(19) United States
(12) Patent Application Publication
(10) Pub. No.: US 2002/0099685 A1
(43) Pub. Date: Jul. 25, 2002

(54) Document retrieval system; method of document retrieval; and search server

(75) Inventors: Akihiko Takano, Higashimatsuyama (JP); Toru Hisamitsu, Oi (JP); Makoto Iwayama, Tokorozawa (JP); Osamu Imaichi, Hatoyama (JP); Shingo Nishioka, Higashimatsuyama (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 09/916,273

(22) Filed: Jul. 30, 2001

(30) Foreign Application Priority Data
Jan. 25, 2001 (JP) 2001-017522

(51) Int. Cl. G06F 7/00

(52) U.S. Cl. 707/1

(57) ABSTRACT

A system and method for searching both keyword-search-type databases and associative-document-search-type databases with a single search query. All or a part of the search results returned from an initial search may be used to construct a query for a subsequent search in the same or a different database. A search server may provide results to a document retrieval terminal in a merged form with document identifiers from several different types of databases. The search server may prompt a user to modify and confirm a constructed Boolean search to make sure that the search is syntactically correct for a given keyword-type-search database.

### PRIORITY TO FOREIGN APPLICATIONS

This application claims priority to Japanese Patent Application No. P2001-017522.

### BACKGROUND OF THE INVENTION

1. Field of the Invention

The present invention relates to a document retrieval terminal combining different types of databases and a method of document retrieval that issues search requests to a user-selected group of databases including both document-associative-search-type databases and keyword-search-type databases simultaneously, wherein the method permits a subsequent search to be performed using a part of the results of the initial search, in the same or a different group of databases.

2. Description of the Background

With the advent of electronic versions of various types of document information, there is an increasing need to search a plurality of document databases (“DBs”) simultaneously. Technologies for enabling such a search on the World Wide Web (“WWW” or the “Web”), or WWW sites themselves offering such a service are generally referred to as metasearch engines. The client program “SHERLOCK2” included with the MAC operating system of APPLE COMPUTER INC. is a program for implementing metasearch for a plurality of registered search servers. There are many commonly known search sites and programs including various searching features.

In a system as described above, a user-specified search request (a set of keywords) is typically sent to a plurality of common search engines (hereinafter referred to as keyword-search-type databases) such as ALTAVISTA, YAHOO, and GOOGLE, and search results from the search engines are presented in a merged form to the user. The search results are identifiers (URLs —Uniform Resource Locators—in the case of a search for web pages) of documents determined by the search engines to have a high degree of relevance to the search terms.

If desired, after browsing the contents of the search results with a browser, the user may again perform a search using a metasearch engine by adding or changing keywords, or performing other operations. This procedure may be repeated until a relevant document is found. Metasearch engines currently implemented all target keyword-search-type databases. Hereinafter, this type of metasearch engine will be referred to as a “keyword-search-type” metasearch engine.

A keyword-type document search is a search method that accepts a query including keywords combined by AND, OR and/or other Boolean operators input from users and outputs a set of documents (document identifiers) including words matching the input. This method has been widely used from the early stage of document retrieval. The keyword-type document search has been limited in that, if queries are inappropriately specified, a large number of documents including many irrelevant documents might be returned or no matching document may be found at all. Many search attempts are often required before a relevant document is found, and a search may not always result in an accurate result. However, keyword-search-type databases are used in many systems because they are relatively simple in construction and operate at a high speed despite their large size.

In contrast to the keyword search, a search method referred to as an associative document search is also available. According to this method, users generally specify a plurality of documents, instead of using specific keywords, as queries to search similar documents. Databases enabling such searches will be referred to herein as associative-document-search-type databases. The associative document search regards a document as a set of words and represents it as a vector of words. Therefore, documents specified by identifiers, a part of a document copied to a clipboard, and words input to a keyword input area are all regarded as part of the “document” (a single word would be regarded as a document consisting of one word) and represented as a vector of words.

On the other hand, document groups in a document database are all represented as word vectors, and the similarity between a key document and a searched document is defined as a distance between vectors. Documents in the document database that are highly similar to the key document are displayed as a search result.

The associative document search enables users to perform searches without having to specify specific keywords combined by Boolean expressions by transferring a part of document on hand directly to a clipboard, and if a relevant document is found, to immediately perform a subsequent search using the found document as the query. Therefore, the associative document search is more user-friendly than the keyword search. However, since calculation of an associative search is expensive and time-consuming, it is not easy to search a large-scale document database. Because of this, only a small number of associative-document-search-type databases are presently available. Associative-document-search-type database metasearch engines capable of collectively searching the associative-document-search-type databases are not currently available.

There is also no intelligent metasearch engine that enables a search to be performed across both keyword-search-type databases and associative-document-search-type databases. Conventionally, when users find an interesting document in an associative-document-search-type database, they may attempt to find further relevant documents using a keyword-search-type search engine. However, the usersw typically have to generate or extract the search keywords by themselves, start up a browser for the keyword-search-type search engine, and then input the keywords into a keyword area of the search engine. Linkage between the associative-document-search-type database and the keyword-search-type search engine has not been supported.

In much the same way, when users find an interesting document in a keyword-search-type database, they may attempt to find documents relevant to the document using an associative-document-search-type search engine. Again, this second search typically requires the user to extract keywords by themselves, start up a browser for the associative-document-search-type search engine, and then input the terms into a keyword area thereof. Linkage between the keyword-search-type database and the associative-document-search-type search engine has not been supported.

### SUMMARY OF THE INVENTION

In at least one embodiment, the present invention preferably provides a search interface that provides increased convenience for users by linking the results of searching both keyword-search-type databases and associative-document-search-type databases. Also, the present invention may provide a document retrieval method that enables at least two types of databases, e.g., keyword-search-type databases and associative-document-search-type databases, to be seamlessly searched by linking the results of searching both. Further, the present invention provides a search server to enable such a document retrieval method.

To address one or more of the above limitations of the conventional methods, the following four functions are preferably implemented at the same time.

(1) A function to use words in documents obtained by a search of a keyword-search-type database to search a plurality of keyword-search-type databases. In this case, users individually need not start up a client for the targeted keyword-search-type databases.

(2) A function to use words in documents or a part of the documents obtained by a search of a keyword-search-type database to search a plurality of associative-document-search-type databases. In this case, users individually need not start up a client for the targeted associative-document-search-type databases.

(3) A function to select identifiers of documents obtained by a search of an associative-document-search-type database to search a plurality of keyword-search-type databases for documents relevant to the obtained documents. In this case, users individually need not start up a client for the targeted keyword-search-type databases.

(4) A function to select identifiers of documents obtained by searching an associative-document-search-type database to search a plurality of associative-document-search-type databases for documents similar to the obtained documents. In this case, users individually need not start up a client for the targeted associative-document-search-type databases.

The function (1) may be implemented if users are able to specify new search terms and input them into a keyword area for subsequent searches. This functionality may be at least partially implemented by common keyword-search-type database metasearch engines in which a plurality of keyword-search-type databases are consulted at the same time and obtained results are merged by some method. The function (2) may be implemented by regarding keywords or a part of document as a document, as in searches targeted for a single associative-document-search-type database.

The function (4) may be implemented by the method disclosed in JP-A-155758/2000. Specifically, it may be implemented by providing a search server (associative-document-search server) of associative-document-search-type databases with a function for selecting topic words from a specified document group to create a summary and a function for searching the databases for similar documents according to a sent summary. Thereafter, the system preferably puts the search server under the control of a network. Finally, the method provides a search system serving as a client with the functionality for specifying a document group for the associative-document-search server of document databases in which document groups obtained as a result of searching similar documents are stored, for receiving a summary of the document group, for sending the received summary to an associative-document-search server of document databases to be searched, and for receiving search results.

There is disclosed in Japanese Published Unexamined Patent Application No. 2000-155758 a system that uses a document in a single database to issue a search request to another single database. The system may be expanded to be capable of processing search requests between multiple databases and multiple databases of a different type. Hereinafter, the term “associative-document-search-type databases” will, unless otherwise noted, refer to databases having the summarizing function and the function for retrieving similar documents on the basis of a summary, as described in Japanese Published Unexamined Patent Application No. 2000-155758.

Lastly, the function (3) may be implemented, as in the implementation of the function (4), by providing an associative-document-search server with the summarizing function for selecting topic words from a specified document group to create a summary. By using such an associative-document-search server, topic words included in user-specified document identifiers of those obtained in the searching of associative-document-search-type databases may be obtained. By presenting these document identifiers to users who can select keywords from them, the users may issue a search request to keyword-search-type databases using search results of the associative-document-search-type databases. Methods for simultaneously consulting a plurality of keyword-search-type databases and merging the results may exist in conventional keyword-search-type metasearch engines, as described above.

A least one embodiment of the present invention, by using the above-described four techniques, preferably provides a search interface that enables users to perform searching by linking a plurality of associative-document-search servers and a plurality of keyword-search servers.

In this specification, the term “document” refers to “a set of statements having meaningful contents written in natural or other language” and denotes the unit of data to be searched that can be retrieved from databases. More specifically, the documents may include, for example: a newspaper story; an encyclopedia entry; a volume of a book; a paper; and/or a set of HTML text messages having meaningful contents generally called a home page, wherein the HTML text messages are being mutually referenced by hypertext functions. However, since the unit of “meaningful contents” changes depending on purposes, a chapter of a paper or book, a small entry of an encyclopedia, and an individual HTML text message as well as the entire paper or book and encyclopedia entries may all be considered to be a document or set of documents.

Non-language data (image data, base sequence data, etc.) accompanied by a description in natural language is also preferably considered to be a document. Documents referred to in the present invention include various cases as described above. Document identifiers (“IDs”) refer to names assigned to individual documents on a one-to-one basis to uniquely identify the documents. So long as this condition is satisfied, identifiers may be of whatever form, such as document titles written in natural language, numbers, or icons and other non-text data.

One or more of the above-mentioned limitations in the prior art may also be addressed by other exemplary embodiments of the present invention. For example, a document retrieval system according to the present invention may include: (a) a document information display part for displaying document information sent as search results; (b) a document content display means for displaying document contents displayed in the document information display part; (c) selecting means for selecting a part or all of document contents displayed by the document content display means; (d) a search button for initiating a document retrieval by using as queries a part or all of document contents selected by the selecting means; and (e) means for confirming and modifying a Boolean expression for associating a plurality of words included in the queries.

Various embodiments of the present invention may also include other features such as a topic word display part for displaying topic words included in a document displayed in the document information display part and word selecting means for selecting words displayed in the topic word display part. Various embodiments may also include a database selecting part for selecting one or more databases to be searched from a plurality of databases including keyword-search-type databases and associative-document-search-type databases.

The above-described exemplary information search system may be implemented by loading programs recorded in recording media such as a floppy disk, CD-ROM (compact disc —read only memory), CD-R/RW (compact disc recordable/re-writeable), and MO (magnetic optical disk), programs distributed over a network into a computer memory or other methods of data transfer or program implementation.

Various embodiments of the present invention also preferably includes methods and search servers for carrying out the various searches that may combine keyword-search-type databases and associative-document-search-type databases. These databases may return results useful in creating a search query and searching one or more additional databases of the same or different type. Preferably, the system, method, and server provide a seamless integration of disparate databases.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a configuration of a multi-document database search system;

FIG. 2 shows a hardware configuration of a search client;

FIG. 3 shows an example of a search support interface;

FIG. 4 is a flow chart showing the flow of data among a search client, a search driver, and document DBs when a user starts a search by inputting keywords into a keyword input area;

FIG. 5 is a flow chart showing the flow of data among a search client, a search driver, and document DBs when a user uses, as queries, documents returned from an associative-document-search-type server as a result of searching and performs a subsequent search;

FIG. 6 is a flow chart showing the flow of data among a search client, a search driver, and document DBs when a user uses, as queries, topic words in documents obtained as a result of searching and performs a subsequent search;

FIG. 7 is a flow chart showing the flow of data among a search client, a search driver, and document DBs when a user performs a subsequent search by inputting keywords to a keyword input area;

FIG. 8 is a flow chart showing the flow of data among a search client, a search driver, and document DBs when a user copies a part of a document onto a clipboard and uses it as a query to perform a subsequent search;

FIG. 9 shows an example of a window for confirming and modifying a search request to a keyword-search-type databases;

FIG. 10 shows a window at the start of a search;

FIG. 11 shows a window for displaying search results;

FIG. 12 shows a window in which a topic word area is hidden;

FIG. 13 shows a window in which a document area is hidden;

FIG. 14 shows a window in which a database specification area is hidden;

FIG. 15 shows a window when only keyword-search-type databases are selected to perform a keyword search;

FIG. 16 shows a window when associative-document-search-type databases are selected to perform a clipboard search;

FIG. 17 shows a window in which “Alzheimer” has been input to a keyword input box, and associative-document-search-type databases and keyword-search-type databases have been selected as the databases to be searched;

FIG. 18 shows an example of a search result in FIG. 17;

FIG. 19 is an example of a case where, in response to the search result of FIG. 18, the databases to be searched are changed to keyword-search-type databases and documents obtained from associative-document-search-type databases are used as queries to perform a subsequent search;

FIG. 20 shows an example of a window for confirming and modifying a search request;

FIG. 21 shows an example of a search result;

FIG. 22 shows an example of a case where, in response to the search result of FIG. 18, the databases to be searched are switched to only keyword-search-type databases and queries are selected directly from a topic word set to perform a subsequent search;

FIG. 23 shows an example of a window for confirming and modifying a search request;

FIG. 24 shows an example of a search result;

FIG. 25 shows an example of a case where, in response to the search result of FIG. 18, the databases to be searched are switched to only associative-document-search-type databases and documents obtained from associative-document-search-type databases are used as queries to perform a subsequent search;

FIG. 26 shows an example of a search result;

FIG. 27 shows an example of a case where, in response to the search result of FIG. 18, the databases to be searched are switched to only associative-document-search-type databases and queries are selected directly from a topic word set; and

FIG. 28 shows an example of a search result.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

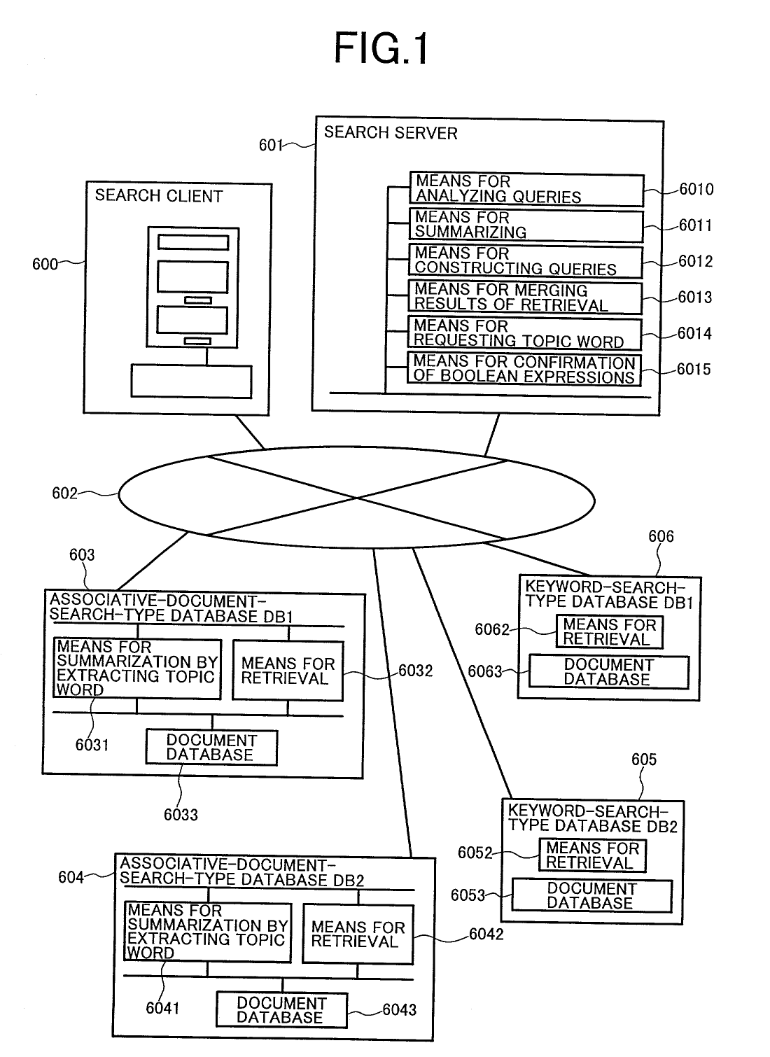

FIG. 1 is a schematic view showing a system configuration for implementing a search method according to at least one embodiment of the present invention. This system preferably comprises a search client 600 that provides a search interface through which users input groups of queries and databases to be searched and on which search results are displayed, search databases 603 to 606 serving as document servers, and a search server 601 intervening between the search client 600 and the search databases 603 to 606, which are connected over a network 602. As the search databases, associative-document-search-type databases 603 and 604, and keyword-search-type databases 605 and 606 coexist. Although, in the example shown, two associative-document-search-type databases and two keyword-search-type databases are connected to the network 602, any number of databases may be connected to the network 602.

The keyword-search-type DBs 605 and 606 have retrieval means (6052 and 6062), and document DBs (6053 and 6063), receive Boolean expressions (AND, OR, etc.) as keywords and return the identifiers of documents corresponding to the keywords together with some relevance score. The associative-document-search-type DBs 603 and 604 preferably have summarizing means (6031 and 6041), retrieval means (6032 and 6042) using topic words, and document DBs (6033 and 6043).

The summarizing means (6031 and 6041) of the associative-document-search-type DBs creates a summary of a document group retrieved from the document DBs (6033 and 6043). The summary refers to a set of topic words representative of the contents of the document group. As the summarizing means, existing means such as those described in JP-A-62693/1997, may be used.

As an example of a summary algorithm, all documents in a document group from which to create a summary may be split into words to find the frequency of occurrence of each word. Words occurring more frequently in a document group are more likely to be included in a summary because they are generally highly representative of the document group. However, common words occurring frequently in any document such as “do” are not appropriate as topic words. Therefore, to select specific words as topic words, the frequency of occurrence of the words in a document DB to which a document group including the words belongs is usually also taken into account.

Specifically, words that occur more frequently in a specified document group and less frequently in the entire document DB are more characteristic of the document group in the sense that the words occur only in the document group, and these words are more appropriate as topic words for characterizing the document group. To be more specific, the weight of each word in a document group is preferably calculated by a function that has an occurrence frequency in the document group and an occurrence frequency in the entire document DB as input parameters and words having a weight greater than a given threshold value are adopted as topic words.

The retrieval means (6032 and 6042) including an associative-document-search-type DB preferably search the document DBs (6033 and 6043) for a document group that is relevant to the topic words of a document group sent from the search server 601 and return document identifiers of search results to the search server 601 together with relevance weights. The retrieval means may be implemented by a prior art keyword search method. In short, since the input topic words of the document group are a set of weighted words, an “OR” search may be performed by treating the topic words as weighted input keywords.

In this case, the document weights (relevance) of search results may be calculated as follows. For each of the words included in both the topic words and a searched document, an overall weight is calculated from the weight of the word in the topic words and the weight (e.g., frequency) of the word in the searched document (e.g., product of both weights), and the weights of all such words may be summed (totaled) to obtain a relevance score.

The search server 601 intervenes between the search client (client program) 600 and the associative-document-search-type DBs 603 and 604 and the keyword-search-type DBs 605 and 606. The search server 601 preferably comprises query analyzing means 6010, summarizing means 6011, query constructing means 6012, search result merging means 6013, topic word requesting means 6014, and Boolean expression confirmation means 6015.

The query analyzing means 6010 analyzes a part of the document sent from the search client 600 to identify words included therein or translates queries into the language of a DB to be searched when the queries and the DB to be searched are written in different languages. The query analyzing means 6010 may have any configuration but preferably includes the functionality to split Japanese statements into a unit (morphological analysis), to restore words to their root forms for English statements (stemming), and to tag the parts-of-speech for all words.

The summarizing means 6011, which extracts topic words from a given word set, preferably has the same functionality as the summarizing means 6031 and 6041 included in the associative-document-search-type DBs 603 and 604. When the search client 600 requests a clipboard search, after transforming a part of document into a word set in the query analyzing means 6010, the search server 601 preferably sends the word set to the summarizing means 6011 to create a summary (that is, select topic words for an abstract) and sends the created summary to the query constructing means 6012.

The query constructing means 6012 distributes search requests to the document DBs 603 to 606 according to queries sent from the search client 600 and the DBs to be searched. The queries sent from the search client 600 preferably consist of a pair of elements including one of: (1) a keyword set; (2) a document part; (3) a Boolean expression modified to conform to the keyword-search-type DB to be searched; and (4) a document ID in a specific associative-document-search-type DB; and the name of the DB to be searched as the second element of the pair.

Where the first element of the queries is (4), the topic word requesting means 6014 requests the target associative-document-search-type DB to create a summary of the document corresponding to the document ID. A returned word set is merged by the search result merging means 6013. The merged word set is sent to the associative-document-search-type DB as queries or is displayed in a topic word area.

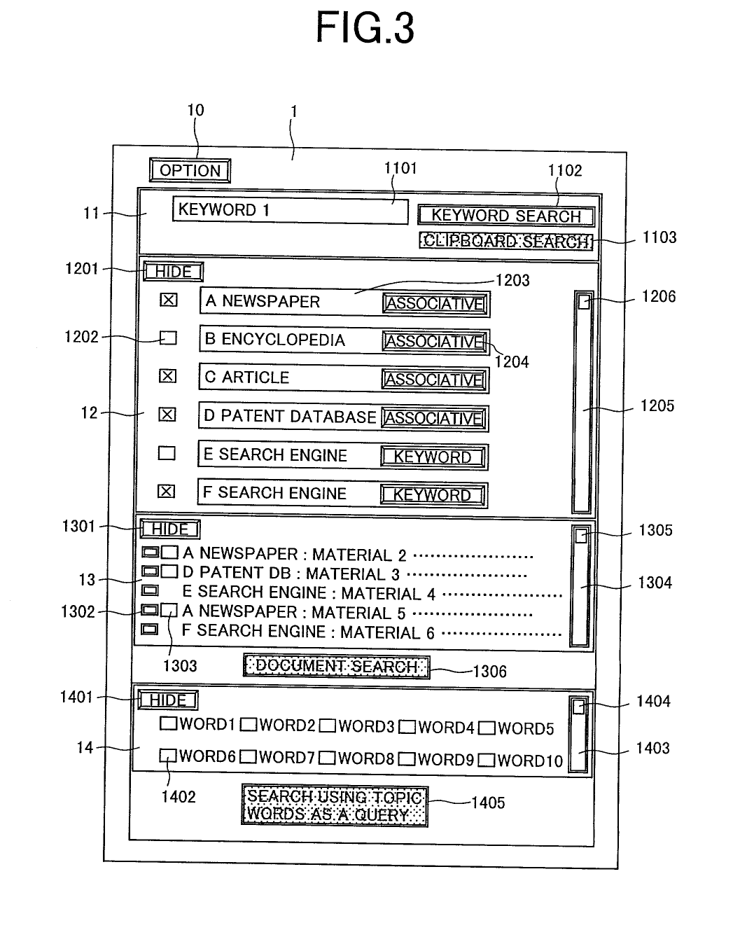

The search result merging means 6013 merges search results returned by the document DBs. Document IDs and topic word sets output as search results may be merged by various methods as already described. Any method may be permitted. The merged document IDs and topic word sets are sent to the search client 600, which displays a set of the merged document IDs in a document area 13 (see FIG. 3) and displays the merged topic word sets in the topic word area 14.

The Boolean expression confirmation means 6015 records information about keyword-search-type DBs, tells the search client 600 whether to inquire of a user about the need to modify a query, and sends a topic word set used in the query and the type of a query a target keyword-search-type DB accepts.

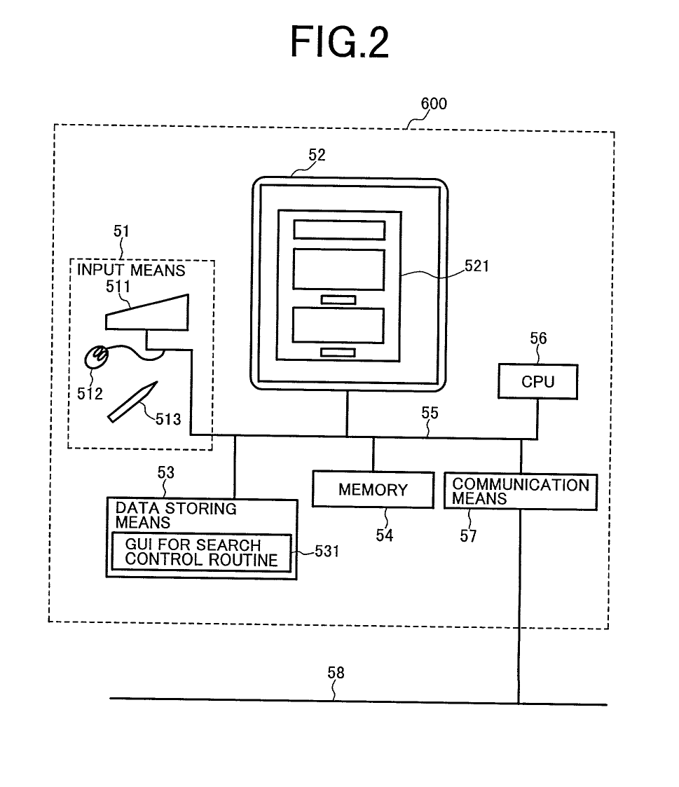

FIG. 2 is a schematic view showing one presently preferred configuration of a search client of the present invention. The search client preferably includes: input means 51 comprising a keyboard 511, a mouse 512, and a pen input means 513; display means 52 comprising a CRT or a liquid crystal display panel; data storing means 53 storing a search interface control routine 531; a memory 54; a CPU 56; and a communication means 57. The various elements are connected to each other through a data bus 55 and connected to an external network 58 via communication means 57.

Various windows may be displayed in the section of a search interface 521 of the display means 52. The search interface control routine 531 controls all operations of the search interface, sends queries to the search server 601, and receives and displays search results from the search server 601. The display of windows, recognition of search requests and specified DB, data exchange with the search server, creation of confirmation window, creation of Boolean expressions, and the determination whether to display or hide a given area are preferably also controlled by the search interface control routine 531.

A description will now be made of an example of the search interface 521 displayed in the display means 52. FIG. 3 shows an example of a search interface of metasearch targeted for both keyword-search-type DBs and associative-document-search-type DBs. Window 1 for supporting metasearch is divided into the following four major areas: a keyword input area 11 for users to directly input keywords; a DB specification area 12 for specifying DBs to be searched; a document area 13 for displaying merged documents obtained as a result of searching the DBs together with identifiers; and a topic word area 14 for displaying topic words in documents obtained as a result of searching.

The keyword input area 11 preferably includes: a keyword input box 1101; a keyword search button 1102; and a clipboard-search button 1103. The clipboard-search button 1103 is used to directly copy and paste a part of a document to an electronic clipboard before issuing a search request to an associative-document-search-type DB.

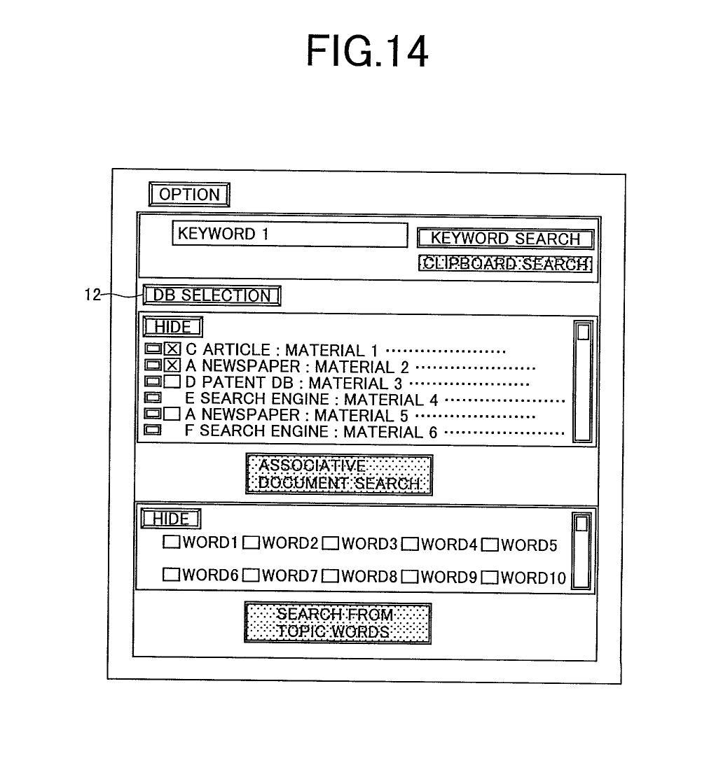

The DB specification area 12 preferably includes: a display button 1201 for selecting whether to display or hide the area; a DB selection button 1202 for checking and selecting a DB to be used; and a DB display box 1203 for displaying a usable DB name. Instead of explicitly displaying the display button 1201 in the form of a button, there may be a “database selection” pull-down menu appearing when the option button 10 is selected (“clicked” with the mouse) that displays the same contents as the DB specification area 12 in FIG. 3.

Where the DB specification area 12 is to be hidden as shown in FIG. 14, the DB specification area 12 may be redisplayed (un-hidden) by selecting the DB selection button 203. Alternatively, the DB specification area 12 may also be redisplayed using a pull-down menu appearing when the option button 10 is selected. The DB display box 1203 includes a DB name and a DB classification mark 1204 indicating whether the database is a keyword search type or a associative document search type database. When there are many DBs, a scroll area 1205 appears, and all of the DBs can be viewed by operating a scroll bar 1206.

The document area 13 preferably also has a display button 1301 for selecting whether to display or hide the area. The document area 13 displays the identifiers of documents obtained as a result of searching in which each identifier comprises the name of a DB from which the displayed document is derived, the identifier of the document in the DB, and a part of the document. Each document identifier is provided with a document browsing button 1302 selected when browsing its contents and a document selecting button 1303 for subsequent searching of similar documents for derivation from an associative-document-search-type DB.

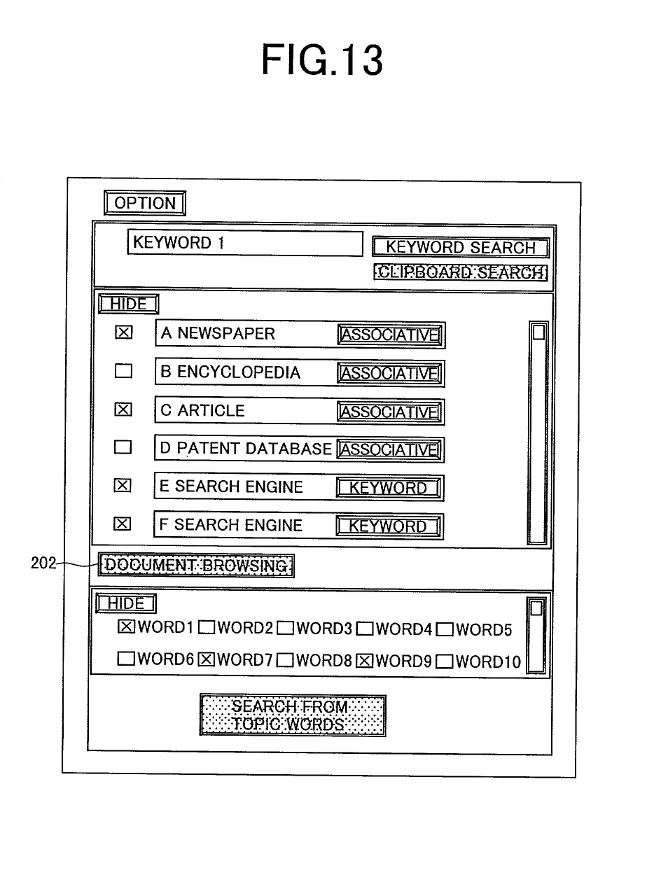

Instead of explicitly displaying the document browsing button 1302 in the form of a button, the same function may be obtained by selecting a document identifier itself. When there are many document identifiers, a scroll area 1304 appears, and all of the document identifiers can be viewed by operating a scroll bar 1305. After the document selecting buttons 1303 have been checked to select documents to be used as queries for an associative document search, a document associative search button 1306 may be selected to perform a subsequent search using the documents as queries. Where the document area is hidden, a document browsing button 202 is displayed as shown in FIG. 13, and the document area can be redisplayed by selecting the document browsing button 202.

The topic word area 14 has a display button 1401 for selecting whether to display or hide the area. The topic word area preferably displays topic words in documents obtained as a result of searching. Each word is provided with a check box 1402 for checking the word when selecting it as a keyword. Since words are returned from an associative document search DB, there may be a box appearing when “number of topic words representative of summary” is selected which is preferably displayed in a pull-down menu when the option button 10 is selected. This box may show the number of topic words specified for each of the associative-document-search-type DBs. When not all the words can be displayed within the window, a scroll area 1403 appears, and all the words can be viewed by operating a scroll bar 1404.

There is no special limitation on the order in which the words are displayed. For example, in a case where for each DB a given number of words might be retrieved from searched documents in ascending order by the probability at which the words occur in the entire DB and the probability is assigned to the words as weights, the words may be displayed in the topic word area 14 in ascending order by the weights. Alternatively, the topic word area 14 may be divided into small areas for each DB so that topic words in each DB are displayed in each small area in the order of weights.

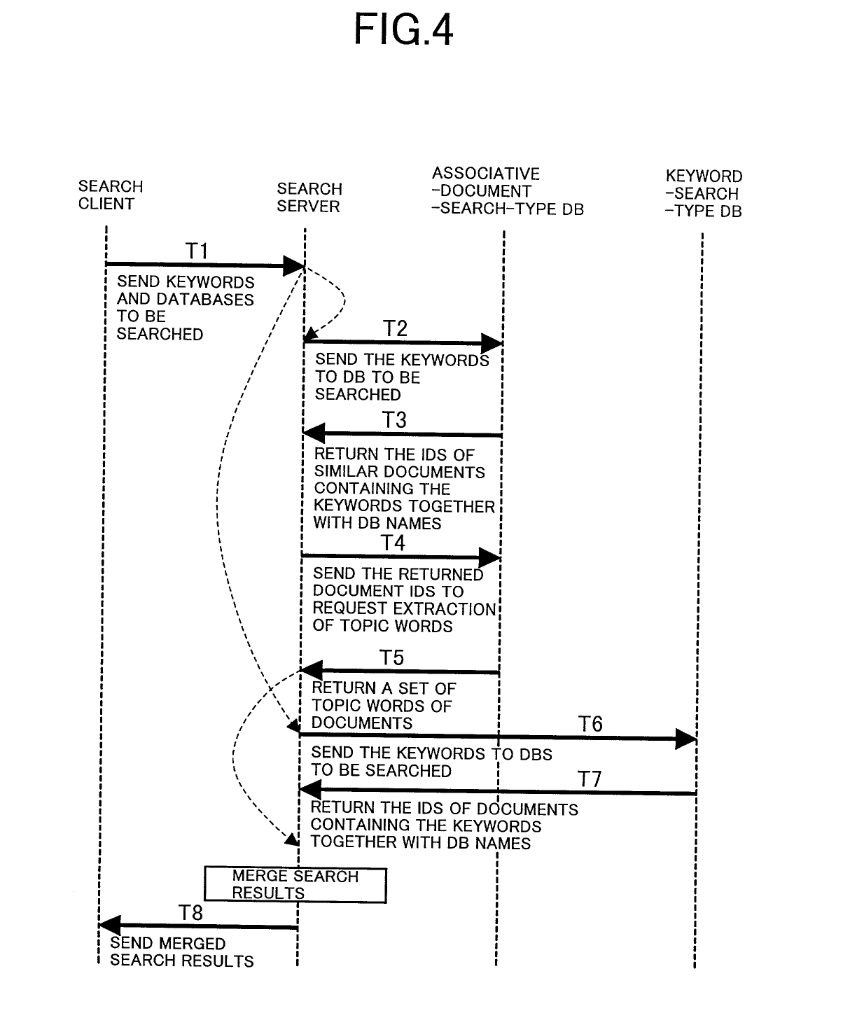

A description will now be made of a document retrieval method by a search system according to the present invention. A document retrieval is performed by the cooperation of the search client 600 and the search server 601. Hereinafter, the flow of data for achieving the document retrieval is described using FIGS. 4 to 8 showing data exchange among the client, the server, and document DBs.

Initially, referring to FIG. 4, a search using keywords is described. Using an interface provided by the search client 600, users specify any number of keyword-search-type DBs and associative-document-search-type DBs from databases to be searched and input keywords to start a search. The keywords are sent to one or more search servers, in the form of a set of pairs of {keyword, DB to be searched} with the keyword being paired with each of user-specified DBs to be searched (T1).

The search server 601 sends the keywords to an associative-document-search-type DB specified as a database to be searched (T2) and receives the ID of a document including the keywords from the associative-document-search-type DB (T3). The search server 601 further sends the returned document ID to the associative-document-search-type DB to request extraction of topic words (T4), and the associative-document-search-type DB returns the result of the extraction (T5).

The search server 601 also sends keywords to a keyword-search-type DB specified as a database to be searched (T6) and receives a result (T7). Finally, the search server 601 merges document IDs and topic words received from the DBs to be searched using the search result merging means 6013. The search server 601 passes a set of pairs of {document ID (which may include a part of the display-use document), DB name} and a set of the merged topic words to the search client 600 (T8), and the search client 600 presents them to the user as a list of search result documents and a list of topic words.

Document IDs and topic word sets output as search results may be merged by any method. For example, document IDs may be displayed collectively for each document DB. Alternatively, after the relevance scores of the document IDs returned by each document DB are normalized for each document DB (the values are divided by a maximum value for that DB), the document IDs may be displayed in ascending order by the normalized relevance values. For document IDs having the same value, the document IDs may be sorted by ID, alphabetically or may be arranged at random. In principle, the data exchange steps shown in FIG. 4 are performed later if the number following T is larger. However, the groups {T6, T7} and {T2, T3, T4, T5} are independent of each other and may be processed in either order.

In the subsequent search by use of search results, the following types of searches are preferably supported: (i) a document-based search specifying document IDs as keys; (ii) a topic-word-based search selecting topic words as keys; (iii) a common keyword search with users inputting keywords to a keyword input area; and (iv) a clipboard search copying a part of document to a clipboard.

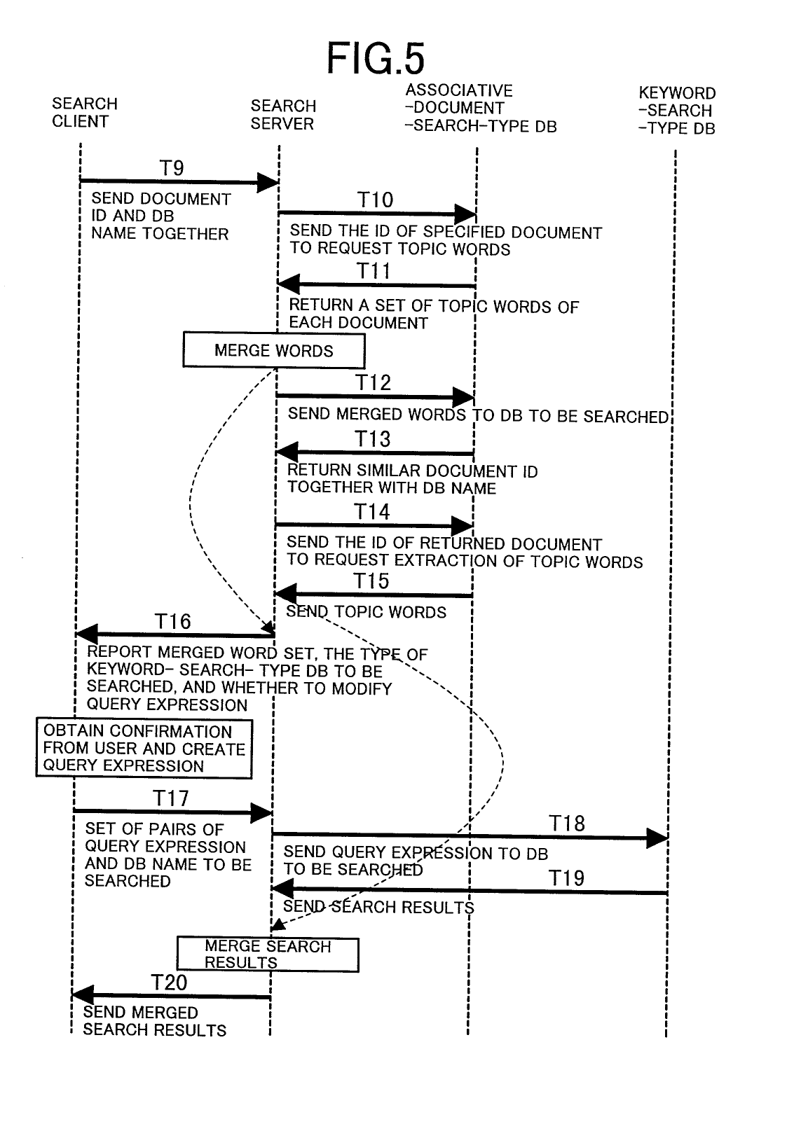

The flow of data for achieving these searches is described with reference to drawings. The document-based search in (i) is preferably performed by users browsing documents returned as a result of searching, checking (selecting) document IDs for documents returned from an associative-document-type server, and selecting (clicking) the document associative search button 1306. The procedure will be described with reference to FIG. 5.

The IDs of specified documents are preferably sent to the search server 601 together with associative-document-search-type DB names specified as search targets (T9). The search server 601 requests associative-document-search-type DBs from which the specified documents are derived to create a set of topic words, which are a set of words occurring saliently (statistically relevant) in the user-specified documents (T10). The associative-document-search-type DBs return a set of topic words of individual documents (T11) When there are a plurality of documents, the search server 601 merges the word sets returned from the associative-document-search-type DBs (represented as M for convenience) and creates a set of pairs of {M, associative-document-search-type DB name specified as a search target}.

After T11, the search server 601 sends a merged word set to the associative-document-search-type DBs specified as search targets (T12), receives document IDs as a result of searching for the word set (T13), issues a request to extract topic words from the documents of the received IDs (T14), and receives the result of the request (T15).

When keyword-search-type DBs are targeted for the subsequent search, M must be modified so as to conform to the keyword-search-type DBs. This is because some keyword-search-type DBs accept all Boolean expressions and others accept only AND or OR expressions. Accordingly, a search request must be sent in the form of query expression which is acceptable by the chosen search engines. Specifically, where OR is accepted, query expressions combined by OR are sent; where only AND is accepted, query expressions combined by AND are sent. In order that the user can confirm and modify the query expressions (either by selecting between AND and OR or by inputting a more complicated Boolean expression if acceptable to the DB), the search server 601 preferably stores information about the search engines in the Boolean expression confirmation means 6015 and reports M, the type of specified keyword-search-type DB, and the need to modify the query expressions to the search client (T16).

In response, the search client 600 preferably prompts the user to confirm the query expressions using M to the keyword-search-type DBs, and the search client 600 creates a set of pairs of {query expression using words of M, keyword-search-type DB name specified as a search target} based on the result and returns the result to the search server (T17). Thereafter, the search server 601 sends keywords to a keyword-search-type DB specified as a search target (T18) and receives search results (T19).

The search server 601 preferably merges the search results of the associative-document-search-type DBs and the keyword-search-type DBs and passes the merged search results to the search client 600 (T20). The search client 600 presents the merged results as a list of search result documents and a list of topic words. In principle, the above-described processing steps are performed later if the number following T is larger. However, the groups {T12, T13, T14, T15} and {T16, T17, T18, T19} are independent of each other and may be processed in either order.

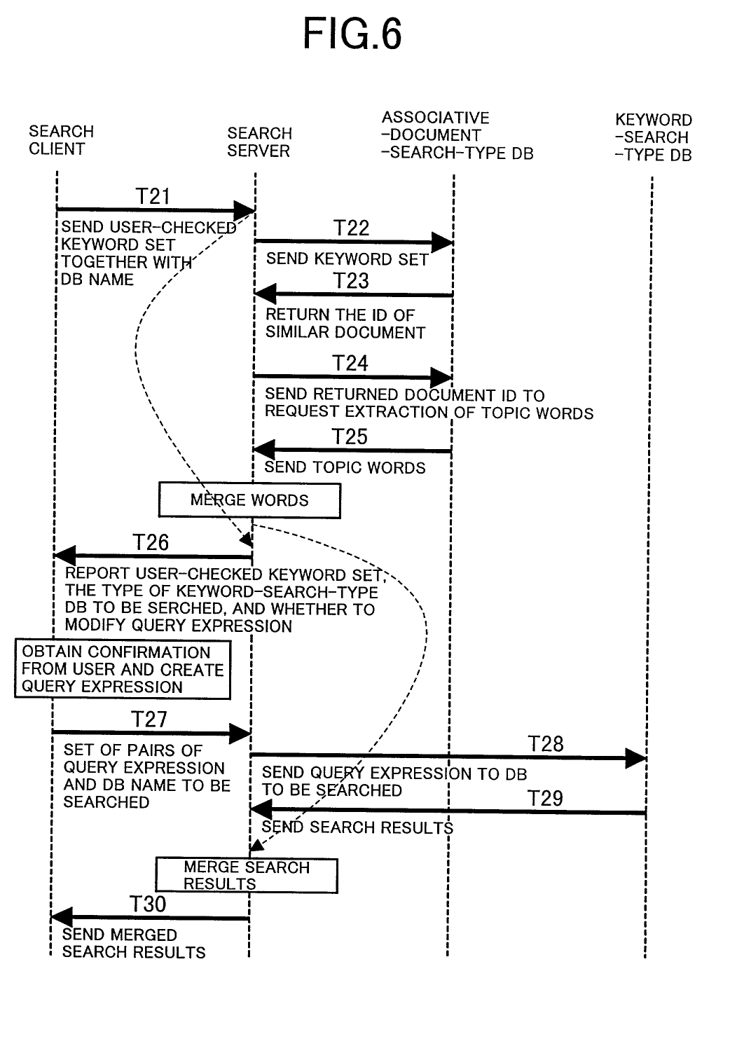

The topic-word-based search in (ii) is preferably performed in a way such that a user selects several words directly from topic words in documents shown together with document IDs (a set of the selected words is herein represented as C), and the user selects (clicks) the topic word search button 1405. The procedure of the topic-word-based search will be described referring to FIG. 6.

The word set C is sent to the search server 601 together with a DB name specified as a search target (T21). If an associative-document-search-type DB is specified as a search target, the search server 601 sends the word set C to the specified associative-document-search-type DB (T22) and receives the ID of a similar document as search results (T23). The search server 601 sends the returned document ID to the associative-document-search-type DB to request extraction of topic words (T24), and the associative-document-search-type DB returns the results of the request (T25). If topic words are returned from a plurality of associative-document-search-type DBs, the search server 601 preferably merges the topic words.

When a keyword-search-type DB is included in the specified search targets, the search server 601 reports the type of the keyword-search-type DB and the request to modify the query expressions to the search client 600 (T26). In response, the search client 600 prompts the user to confirm the query expressions using the word set C to the keyword-search-type DBs, creates a set of pairs of {query expression using words of C, keyword-search-type DB name specified as a search target} based on the result, and returns the result to the search server (T27).

Thereafter, the search server 601 sends the query expressions returned in T27 to the specified keyword-search-type DB (T28) and receives search results (T29) The search server 601 merges the search results as described previously, and sends the merged search results to the search client (T30). The search client 600 presents them as a list of search result documents and a list of topic words.

In principle, the above-described processing steps are performed later if a number following T is larger. However, the groups {T22, T23, T24, T25} and {T26, T27, T28, T29} are independent of each other and may be processed in any order.

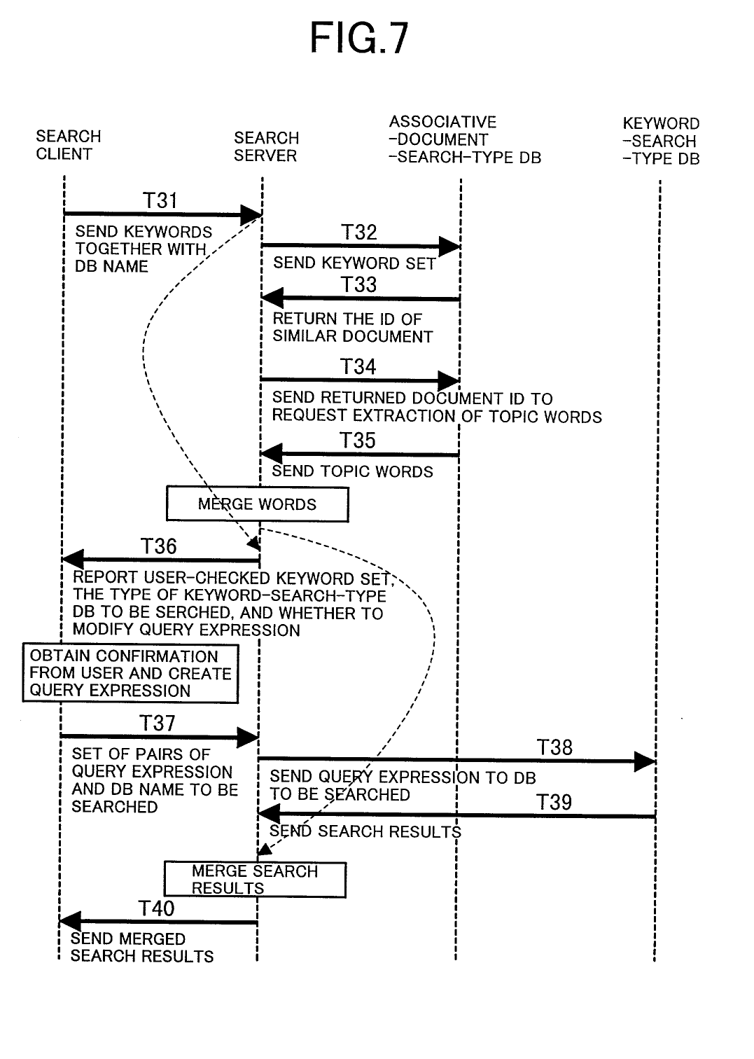

The keyword search in (iii) is preferably performed in a way such that a user inputs keywords to a keyword input area and selects (clicks) the keyword search button 1102. The procedure of the keyword search will now be described referring to FIG. 7.

Where a group of user-input keywords is represented as K, the keyword group K is preferably sent to the search server together with a DB name specified as a search target (T31). If an associative-document-search-type DB is specified as a DB to be searched, the search server 601 sends the keyword group K to the specified associative-document-search-type DB (T32) and receives the ID of a similar document as search results (T33). The search server 601 sends the returned document ID to the associative-document-search-type DB that returned the document ID to request extraction of topic words (T34), and the associative-document-search-type DB returns the results of the request (T35) The search server merges the results.

When keyword-search-type DBs are targeted for the search, the search server 601 preferably reports the type of the keyword-search-type DBs and the request to modify the query expressions to the search client 600 (T36). In response, the search client 600 prompts the user to confirm the query expressions using the keyword group K to the keyword-search-type DBs, creates a set of pairs of {query expression using words of K, keyword-search-type DB name specified as a search target} based on the result, and returns the result to the search server 601 (T37).

Thereafter, the search server 601 sends the query expressions returned in T37 to the specified keyword-search-type DB (T38) and receives search results (T39). The search server 601 merges the search results as described previously and sends the merged search results to the search client 600 (T40). The search client 600 presents them as a list of search result documents and a list of topic words.

In principle, the above-described processing steps are performed later if a number following T is larger.

However, the groups {T32, T33, T34, T35} and {T36, T37, T38, T39} are independent of each other and may be processed in any order.

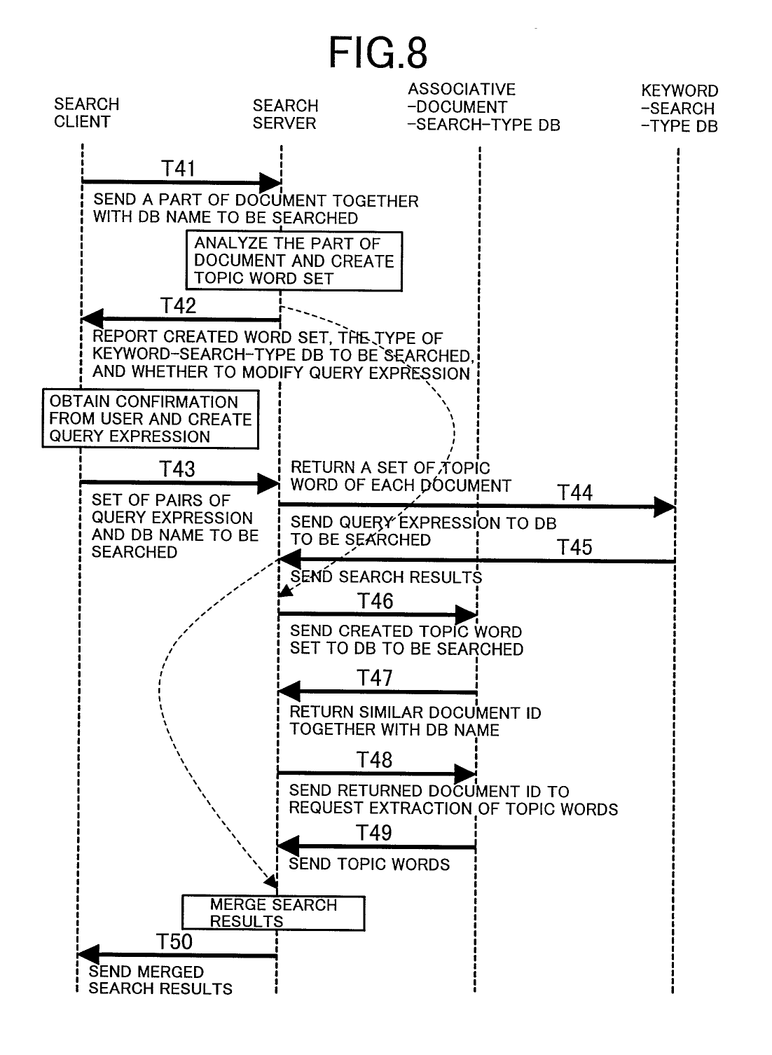

The clipboard search in (iv) is preferably performed in such a way that a user copies a part of a relevant document to a clipboard and selects the clipboard-search button 1103. The procedure of the clipboard search will now be described with reference to FIG. 8.

The user browses documents displayed as search results and copies a part (or all) of the contents of the documents to a clipboard as a query. If a part of document copied to the clipboard is represented as D, the search client sends the part of document D and a DB name specified as a search target to the search server 601 (T41). The search server 601 analyzes D using the query analyzing means 6010 and creates a topic word set DW using the summarizing means 6011.

When a keyword-search-type DB is targeted for the subsequent search, since the topic word set DW must be modified so as to confirm to the keyword-search-type DB, the search server reports the topic word set DW, the type of the keyword-search-type DB, and a request to modify the query expressions to the search client 600 (T42). In response, the search client 600 prompts the user to confirm or modify the query expressions using the topic word set DW to the keyword-search-type DBs, creates a set of pairs of {query expression using words of DW, keyword-search-type DB name specified as a search target} based on the result, and returns the result to the search server 601 (T43). Thereafter, the search server 601 sends keywords to the keyword-search-type DB (T44) and receives search results (T45).

For associative-document-search-type DBs, the search server 601 sends the topic word set DW created after T41 to associative-document-search-type DBs specified as search targets (T46) and receives a document ID as a result of searching for the word set DW (T47). Thereafter, the search server requests the associative-document-search-type DB returning the document ID to extract topic words from a document of the received ID (T48), and the search server receives the result of the request (T49). The search server 601 merges the search results as described previously and passes the merged search results to the search client 600 (T50). The search client 600 presents them as a list of search result documents and a list of topic words.

In principle, the above-described processing steps are performed later if a number following T is larger. However, the groups {T42, T43, T44, T45} and {T46, T47, T48, T49} are independent of each other and may be processed in any order.

Using the obtained search results, a subsequent search may continue in the same way. A subsequent search based on documents returned from keyword-search-type DBs may be performed by the common keyword search or clipboard search. An example of an actual search through an interface of the present invention will be described further below. In this way, a synthetic metasearch of any number of DBs of at least two different types may be combined. Such a search method is referred to as a hybrid metasearch.

The search interface of the search client 600 will now be described in detail. At the completion of browsing documents, where words within the topic word area 14 of the search interface shown in FIG. 3 are used as keys for a subsequent search, relevant words within the topic word area 14 are selected (checked), and the topic word search button 1405 is clicked. Selected words are sent directly to associative-document-search-type DBs via the search server 601.

Where the selected words are sent to keyword-search-type DBs, some DBs accept all Boolean expressions and other DBs accept only AND or OR. Hence, the usage of each search engine is preferably recorded in the Boolean expression confirmation means 6015 of the search server 601, and a search is sent to a search engine using the simplest form of query expression acceptable by each search engine. In order that the user can confirm and modify the query expression (to choose between AND and OR or to input a more complicated Boolean expression if acceptable by the database), a confirmation window is opened.

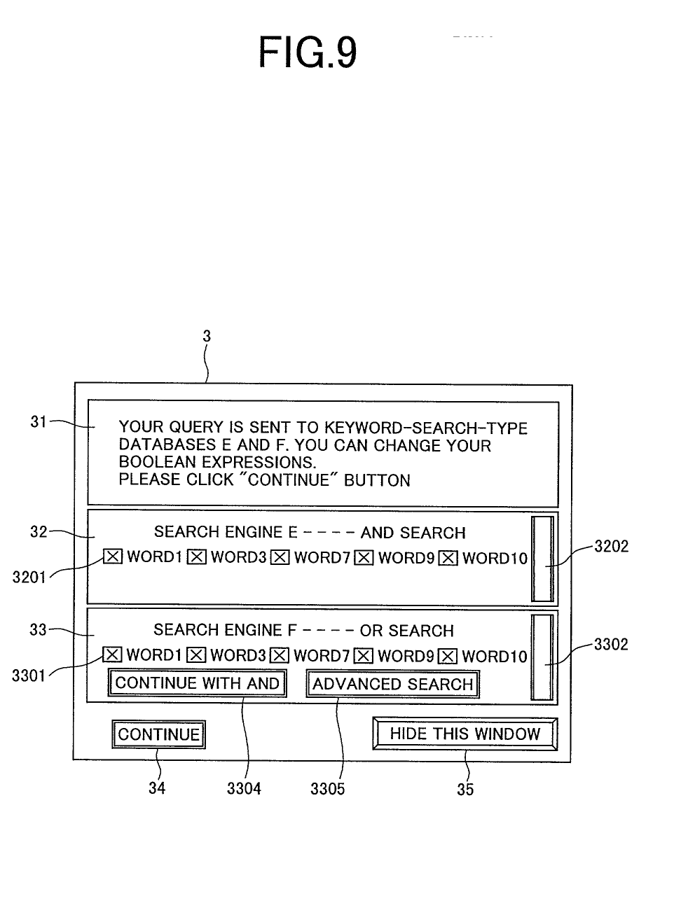

FIG. 9 illustrates an example of a confirmation window. A confirmation window preferably includes a message area 31 and send content display areas 32 and 33 for displaying send contents for each DB. In this example using two DBs, two send content display areas are displayed. The send content display areas 32 and 33 are displayed with pairs including words and associated check boxes. Word check boxes 3201 and 3301 are preferably initialized so that all words are provided with a check mark(selected); however, each of these check marks may be removed. When there are many words, scroll areas 3202 and 3303 are automatically displayed to scroll the areas.

It is assumed herein that a database E (search engine E) accepts only an AND search and a database F (search engine F) accepts other common Boolean expressions as well. For this reason, although only word check boxes are displayed for the database E, an AND-OR replace button 3304 and an advanced search button 3304 for inputting more complicated Boolean expressions are preferably displayed for the database F.

After the contents are confirmed, a continue button 34 is selected to send the contents. A button 35 may be used to hide the confirmation window. Where the confirmation and rewriting of query expressions is difficult, selecting the AND-OR replace button 3304 enables the user to provide instructions so that the system omits displaying the confirmation window 3 and automatically constructs and sends search requests using default query expressions and topic words predetermined for each of keyword-search-type DBs.

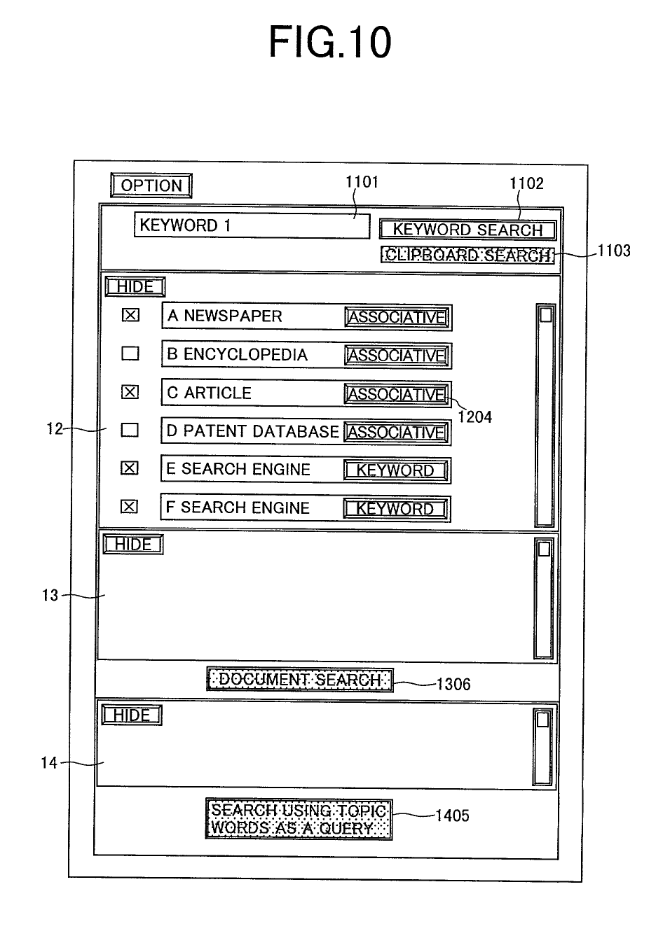

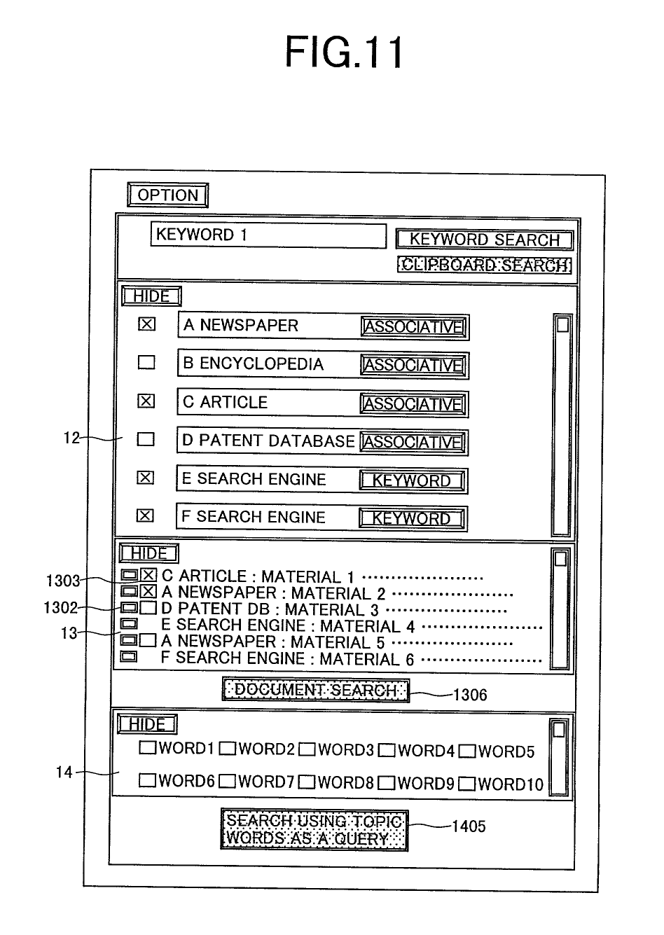

FIG. 10 shows an example that inputs keyword 1 to the keyword input box 1101 of an initial screen and specifies an associative-document-search-type DB and a keyword-search-type DB in the DB specification are 12. FIG. 11 shows a result produced by selecting the keyword search button 1102 in the screen of FIG. 10. The document area 13 and the topic word area 14 now have data.

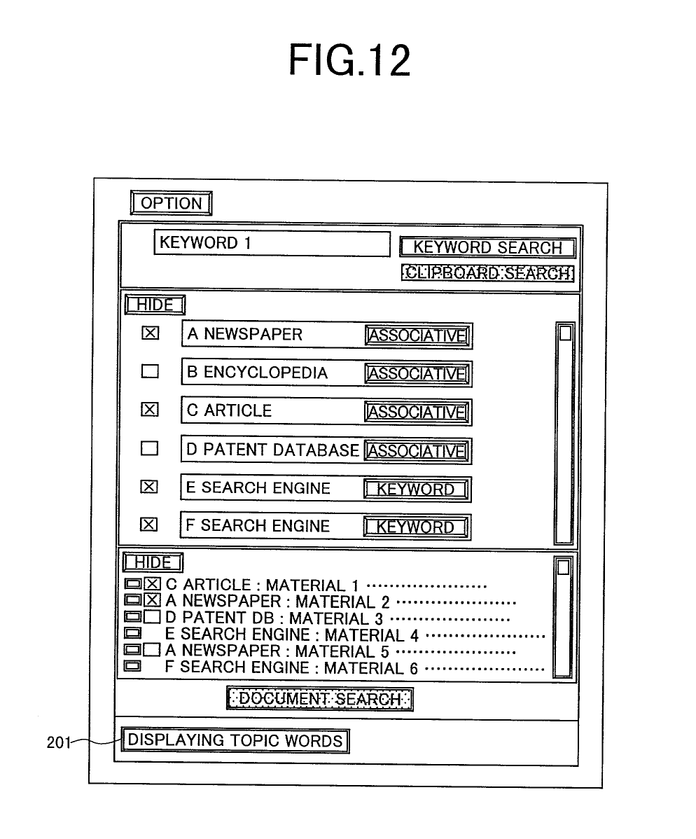

FIG. 12 shows the screen of FIG. 11 with the topic word area 14 hidden. The topic word area is replaced by a topic word display button 201. When the topic word display button 201 is selected in the state shown in FIG. 12, the topic word area 14 is redisplayed.

FIG. 13 shows the screen of FIG. 11 with the document area 13 hidden. The document area 13 is replaced by the document browsing button 202. FIG. 14 shows the screen of FIG. 11 with the DB specification area 12 hidden. The DB specification area 12 is replaced by the DB selection button 203.

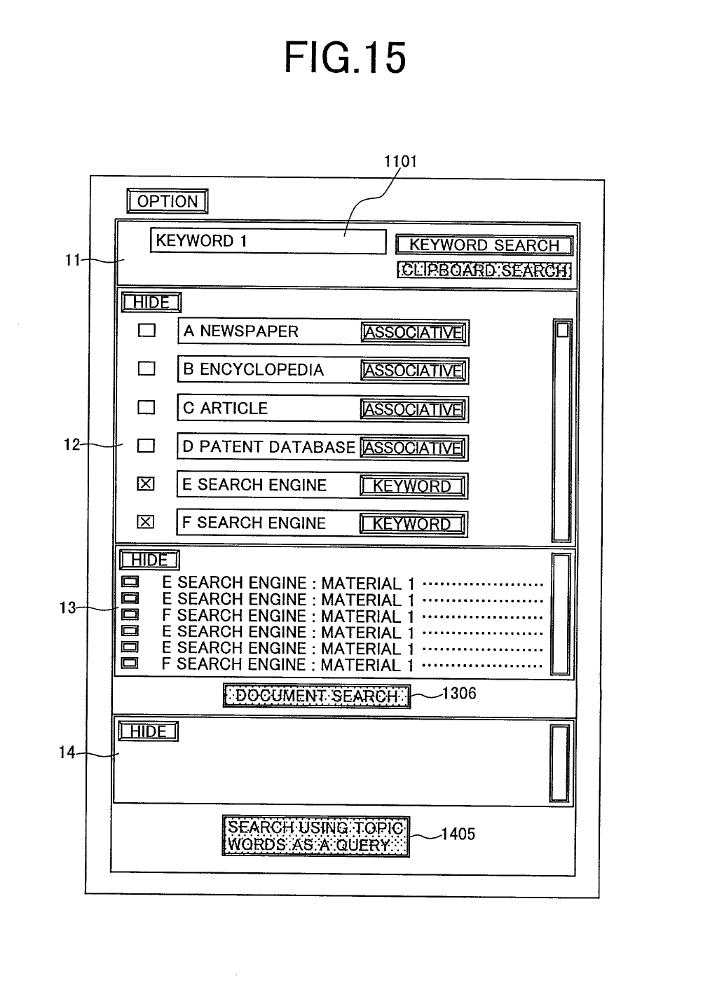

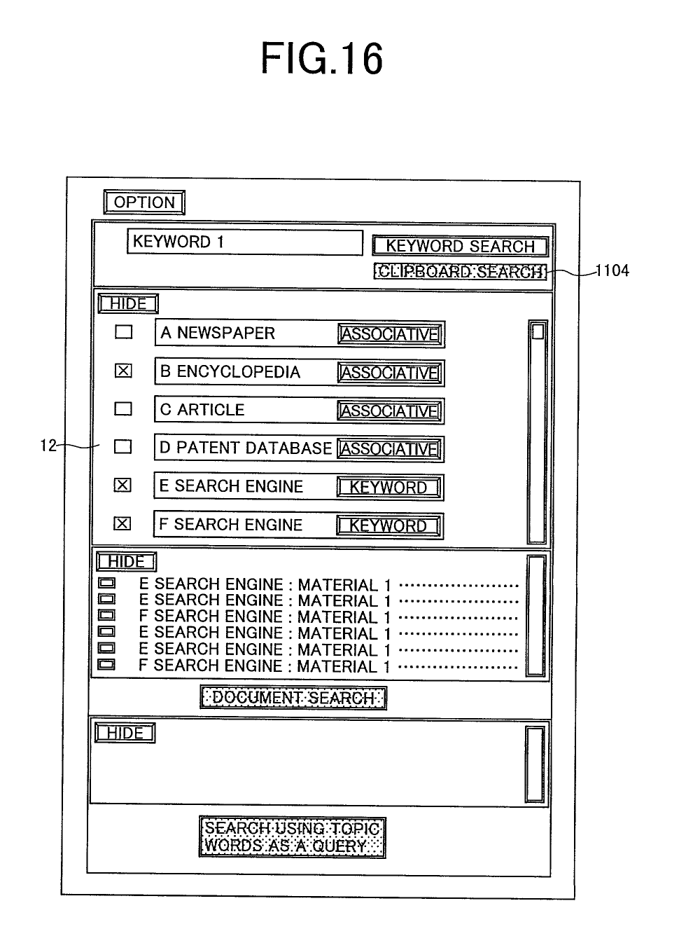

FIG. 15 shows exemplary results of searching with only keyword-search-type DBs specified. FIG. 16 shows the state in which B encyclopedia, an associative-document-search-type DB, is specified after a part of browsed document is copied and pasted to clipboard in the state shown in FIG. 15.

With reference to the drawings briefly described above, an example of using a search interface for a hybrid metasearch will now be described. The following description assumes that, as shown in FIG. 1, a plurality of DBs and a client of hybrid metasearch are connected to a communication network and associative-document-search-type DBs named A Newspaper, B Encyclopedia, C Article, and D Patent DB, and Keyword-search-type DBs such as E Search engine and F Search engine are provided.

As shown in FIG. 10, assume a keyword 1 is input to the keyword input box 1101 of the keyword input area 11. Further assume that the selected target databases include: A Newspaper; C Article; E Search engine; and F Search engine. The DBs are identified as associative document search type or keyword search type by the DB classification mark 1204. In this stage, the document area 13 and the topic word area 14 are empty. The clipboard search button 1103, the document associative search button 1306, and the topic word search button 1405 are all disabled. Herein, shaded buttons indicate that the buttons are disabled.

By selecting (clicking) the keyword search button 1102, the search client 600 sends the keyword 1 to the selected four DBs (A Newspaper, C Article, E Search engine, and F Search engine) through the communication network. A Newspaper and C Article, which are associative-document-search-type DBs, return a predetermined number of identifiers of similar documents and a predetermined number of topic words included in them. E Search engine and F Search engine, which are common keyword-search-type DBs, return a predetermined number of document identifiers. It is assumed that all documents are provided with a relevance score calculated by the searching means of a corresponding DB.

As a result of the searching, as shown in FIG. 11, document identifiers and topic words returned from the DBs are displayed on the display screen of the search client 600. Document identifiers are displayed in the document area 13, and topic words are displayed in the topic word area 14.

Documents displayed in the document area 13 are provided with at least a DB from which they are derived as well as their identifier. Part of the document contents may be included in the identifier. Contents are browsed by selecting the document browsing button 1302. Documents selected as keys (queries) for an associative document search may be checked by clicking the document selecting buttons 1303. The document selecting buttons 1303 are displayed only for documents derived from associative-document-search-type DBs. These documents can be sent as keys to any of selected associative-document-search-type DBs. In other words, if the identifier of a document derived from an associative-document-search-type DB is sent to the DB from which the document is derived, associative-document-search-type DBs return topic words included in them. After topic words returned in this way are merged, an associative document search can be performed for all associative-document-search-type DBs by sending a search request to all associative-document-search-type DBs. Where a document is selected for a search, a search request is made by selecting the document associative search button 1306.

When keyword-search-type DBs are included in the DBs to be searched, the above-described word group is sent. When the word group is sent, an indication should be made of by what Boolean expressions the words are combined. This is because different DBs may accept different forms or types of Boolean expressions in their searches. Accordingly, when the document associative search button 1306 is clicked, if keyword-search-type DBs are included in the DBs to be searched, the confirmation window 3 is displayed as shown in FIG. 9.

In this example, in the interest of simplicity, the word set includes only five words. For the E search engine accepting only AND as a Boolean expression, an indication to send these words combined by AND is set in the send content display area 32. For the F search engine accepting common Boolean expressions, an indication to send these words combined by AND is set in the send content display area 33. To remove a “check” from a word, the word check box is preferably used. When changing a Boolean expression, the AND-OR replace button 3304 or the advanced search button 3305 may be used. When the user has modified and/or confirmed the contents of the query, the user may select the continue button 34.

When a keyword-based search directly selecting and sending keywords instead of a document-based search is performed, the above-described word group returned by associative-document-search-type DBs is displayed in the topic word area 14. The user directly browses these words and selects them using the check buttons, and the user may then select the topic word search button 1405. Also, because only AND may be accepted depending on DBs, the search request is confirmed by the confirmation window 3 in the same way as described in the description of document-base search.

As shown in FIG. 15, where only keyword-search-type DBs are first selected to start a keyword search, all of the returned documents are included in keyword-search-type DBs. Hence, the document selecting button is not displayed in the document area 13, the topic word area 14 is empty, and both the document associative search button 1306 and the topic word search button 1405 are disabled. In this case, as with common keyword-search-type metasearch engines, documents are browsed and appropriate keywords are selected and input to the keyword input area 11 to perform a subsequent search. A difference from common keyword-search-type metasearch engines is that, during subsequent search, as shown in FIG. 16, if an associative-document-search-type DB (B Encyclopedia) is added, a clipboard search may be performed by copying and pasting a part of document to clipboard. In FIG. 16, the clipboard search button 1104 is disabled. By repeating the above procedure, the search can continue until a desired document is found.

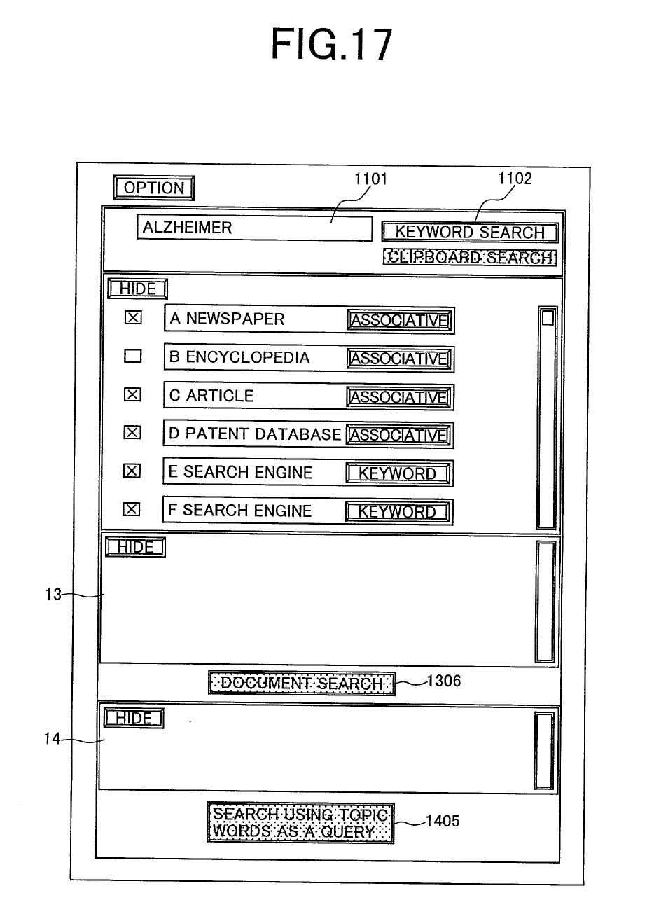

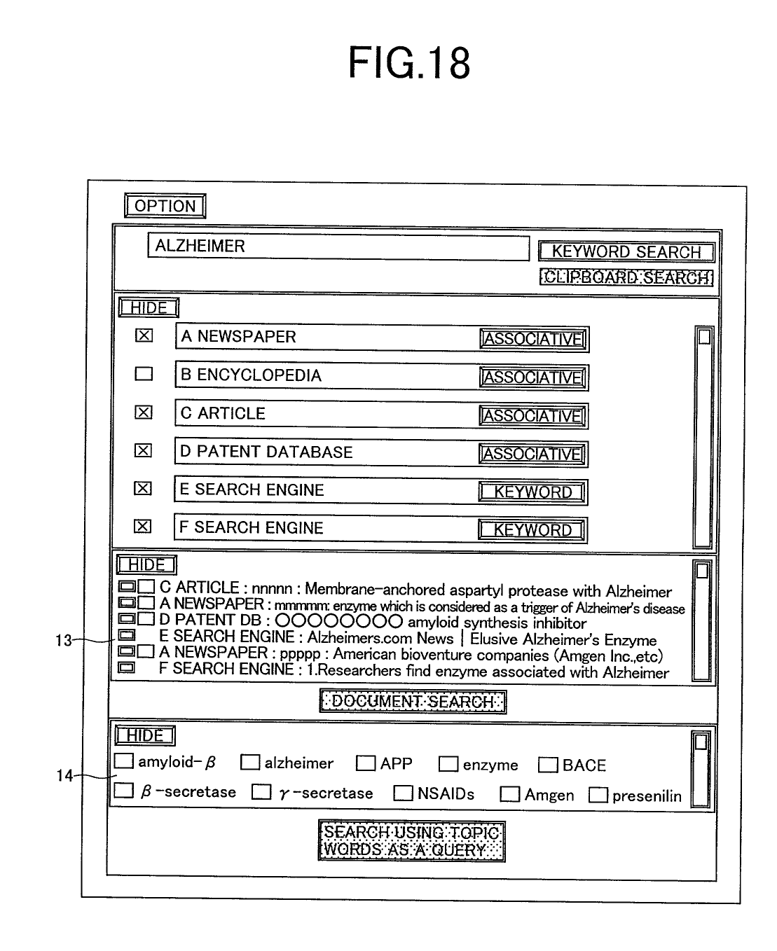

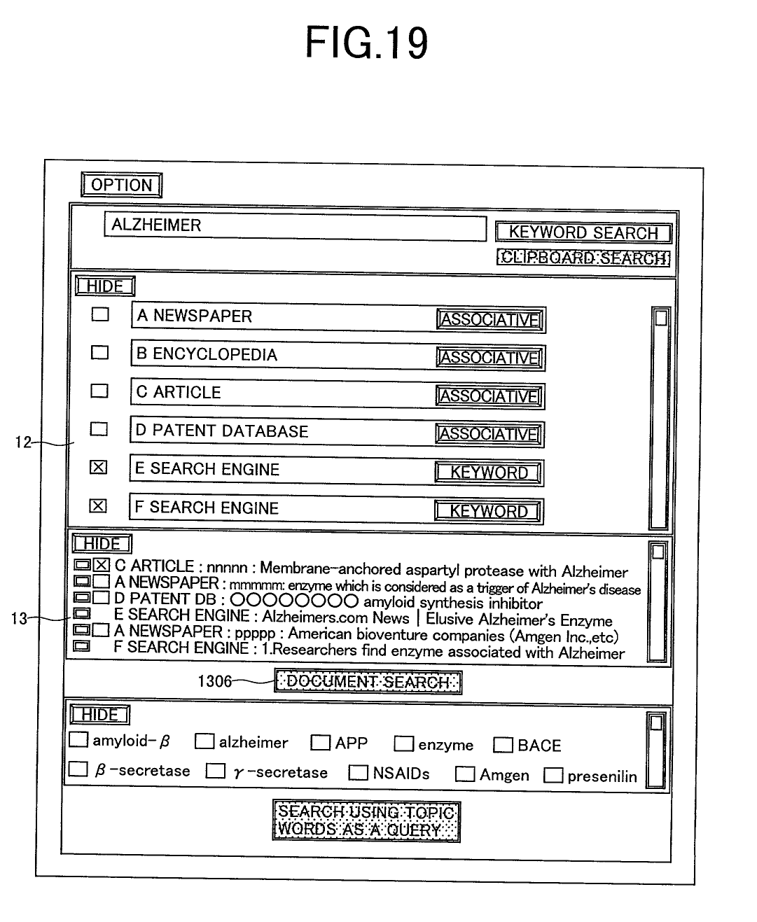

A more concrete example of a hybrid metasearch method of the present invention will now be described for purposes of understanding the present invention. FIGS. 17 and 18 show an example of a hybrid metasearch using of a more concrete search request. The example of FIGS. 19 to 21 use the search results derived from associative-document-search-type DBs as queries, and the example shows a subsequent search of keyword-search-type DBs using the document associative search button.

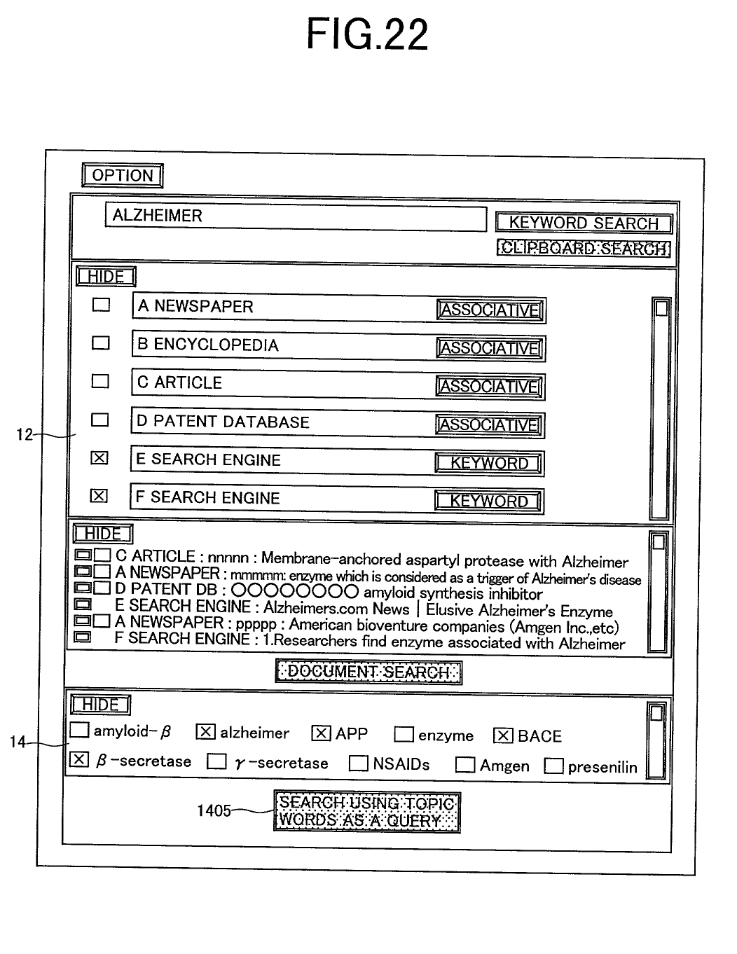

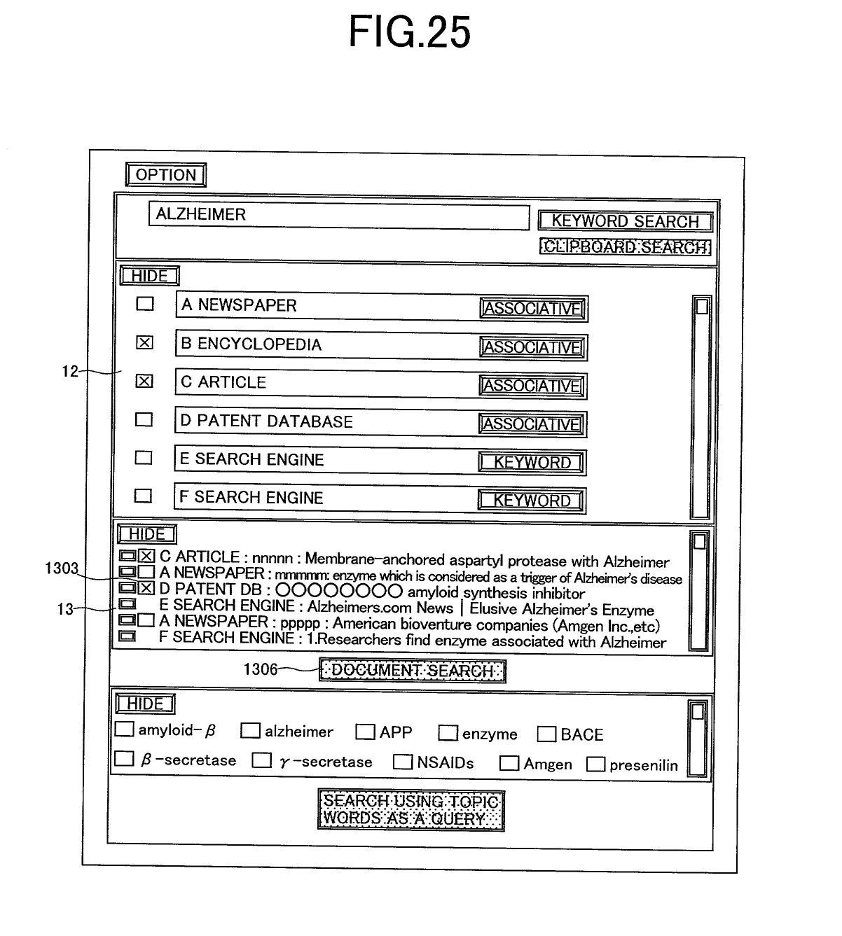

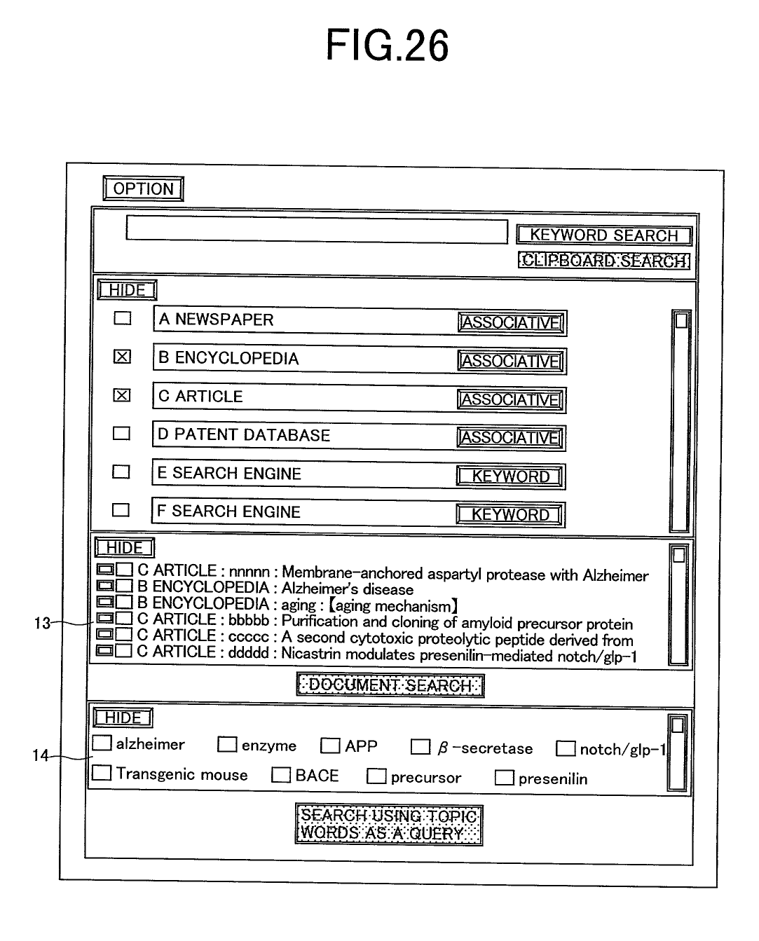

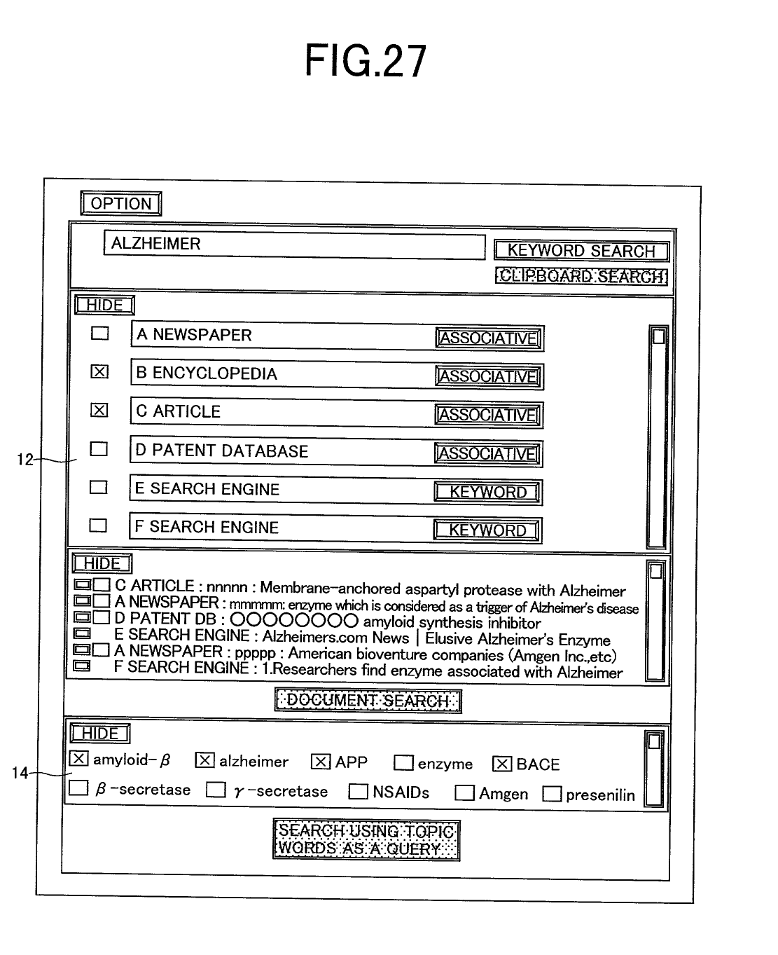

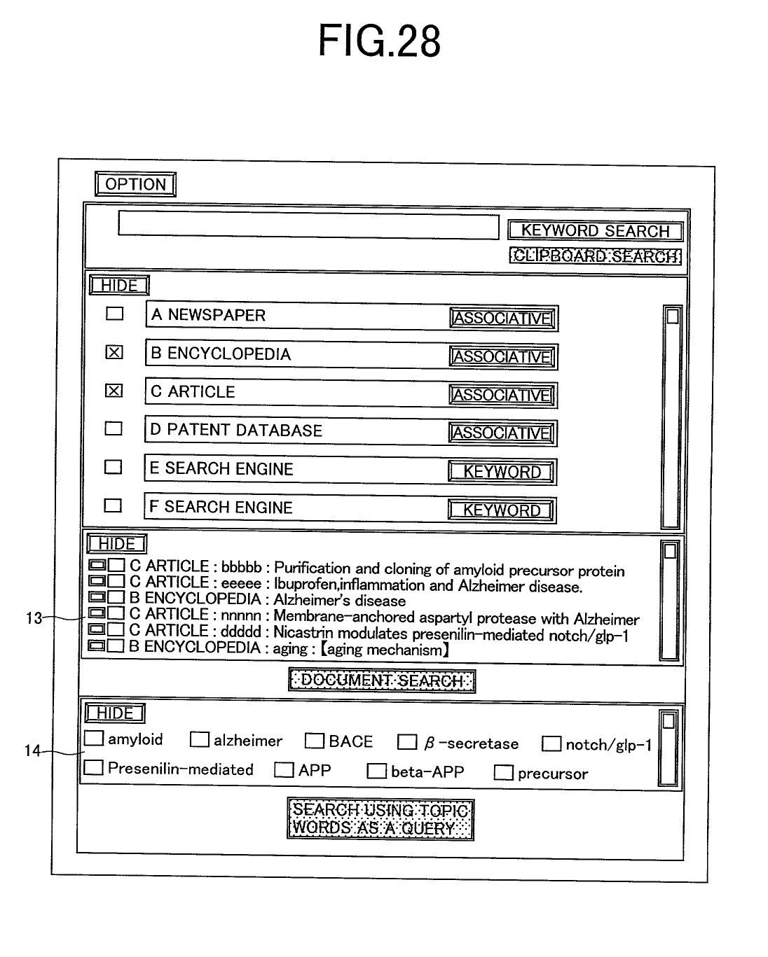

FIGS. 22 to 24 show an example that specifies keywords extracted from search results and a subsequent search of keyword-search-type DBs using the document associative search button. FIGS. 25 and 26 show an example that uses search results derived from associative-document-search-type DBs as queries and a subsequent search of the associative-document-search-type DBs using the document associative search button. FIGS. 27 and 28 show an example that specifies keywords extracted from search results and a subsequent search of associative-document-search-type DBs using the document associative search button.

FIG. 17 shows that “Alzheimer has been input to the keyword input box 1101 and three associative-document-search-type DBs (A Newspaper, C Article, D Patent database) and two keyword-search-type search engines (E, F) have been selected. When the keyword search button 1102 is selected, the information of the keyword “Alzheimer” and the search target DBs (A Newspaper, C Article, D Patent database, E, F) are sent to the search server 601 from the search client 600 by the search interface control routine 531 (T1 of FIG. 4).

In the search server 601, the information is preferably sent to the DBs (A Newspaper, C Article, D Patent database, E, F) by the query constructing means 6012. Since A Newspaper, C Article, and D Patent database are associative-document-search-type DBs, a set of document IDs and a topic word set of the document set are obtained by the processing steps T2 to T5 described in FIG. 4. Since the search engines E and F are keyword-search-type DBs, a set of document IDs is obtained by the processing steps T6 and T7 described in FIG. 4. The search result merging means 6013 of the search server 601 merges the search results and sends the merged search results back to the search client 600. The results are shown in FIG. 18.

FIGS. 19 to 21 show that, after the search results shown in FIG. 18 are obtained, as shown in a DB specification area 12 of FIG. 19, the DBs to be searched are switched to only the keyword-search-type databases E and F. Also, as shown in a document area 13 of FIG. 19, a search is performed using an article obtained from the associative-document-search-type database C as a query.

Upon selecting the document associative search button 1306 on the screen of FIG. 19, a search is started, and the search interface control routine 531 of the search client 600 sends a document ID in the associative-document-search-type DB as a query to the search server (T9 of FIG. 5). The topic word requesting means 6014 of the search server 601 sends the document ID to the associative-document-search-type DB (C Article) and receives a set of topic words in a document indicated by the document ID (T10 and T11). Since search targets are keyword-search-type DBs, the search server 601 notifies the search client 600 of the request to modify the query expression (T16).

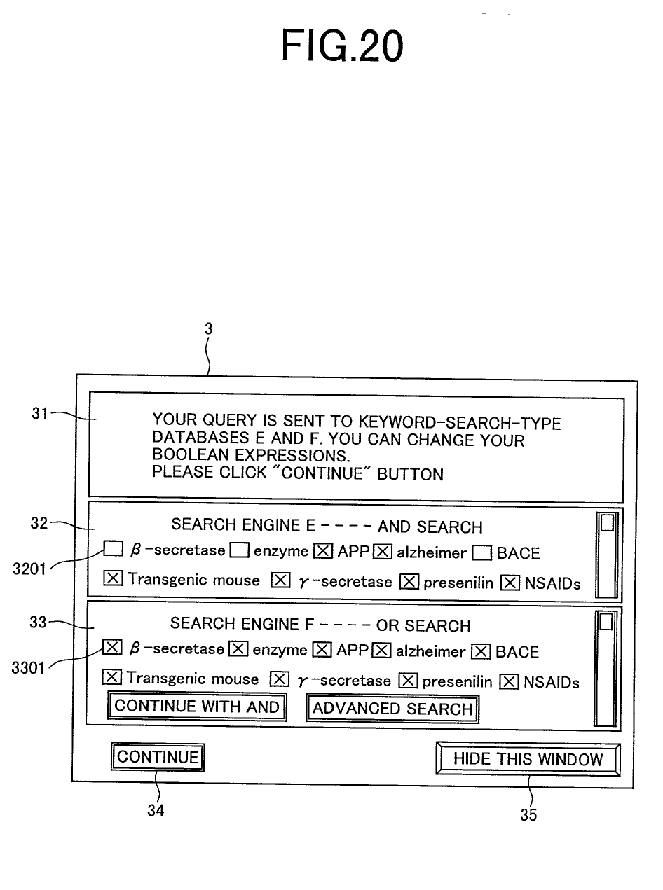

The search interface control routine 531 of the search client, as shown in FIG. 20, displays a search request confirmation/modification window 3 and puts the received word set in the areas 32 and 33. Since it is assumed that the search engine E accepts only AND-type expressions, several words in the area 32 are stripped of their check in the check box 3201.

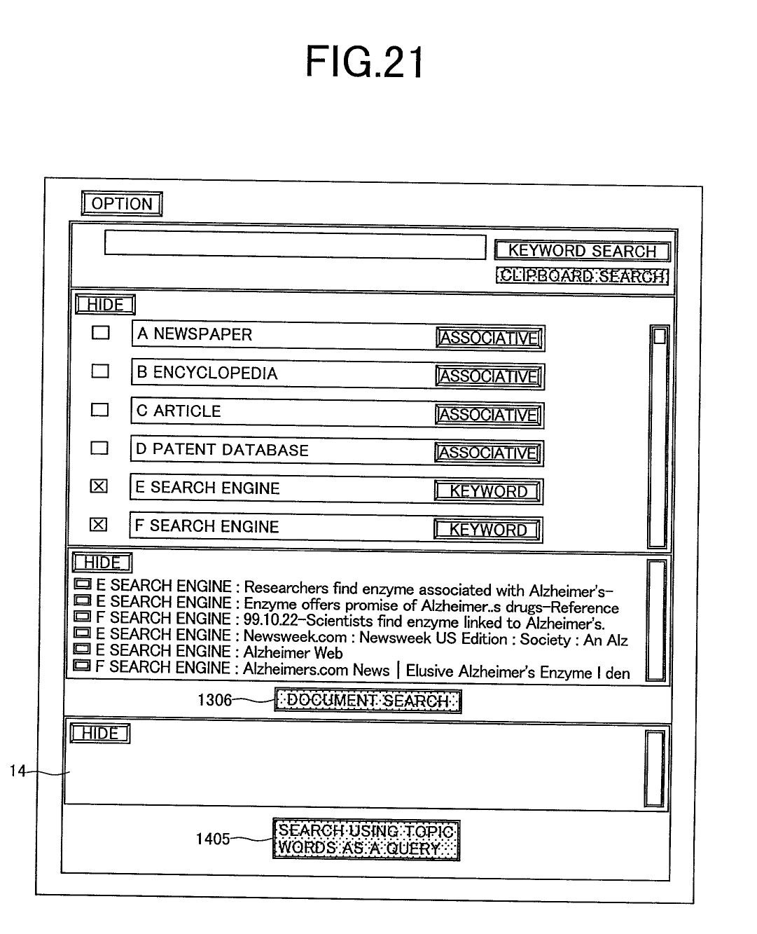

Upon selecting (clicking) the continue button 34, the confirmed Boolean expression is sent to the search server 601 (T17) and sent to the keyword-search-type databases E and F through the query constructing means 6012 of the search server. Search results are then obtained (T18, T19). The search results are merged by the search result merging means 6013 of the search server 601, and the merged search results are returned to the search interface control routine 531 of the search client 600 (T20) . A search result, for example as shown in FIG. 21, is preferably produced. In this case, no topic word set is returned, and because the search targets are keyword-search-type DBs, the topic word area 14 is empty and the document associative search button 1306 and the topic word search button 1405 are disabled.

FIGS. 22 to 24 show that, after the search results shown in FIG. 18 are obtained (see area 12 of FIG. 22), the DBs to be searched are switched to only the keyword-search-type databases E and F, and queries are selected directly from a topic word set displayed in the topic word display area 14.

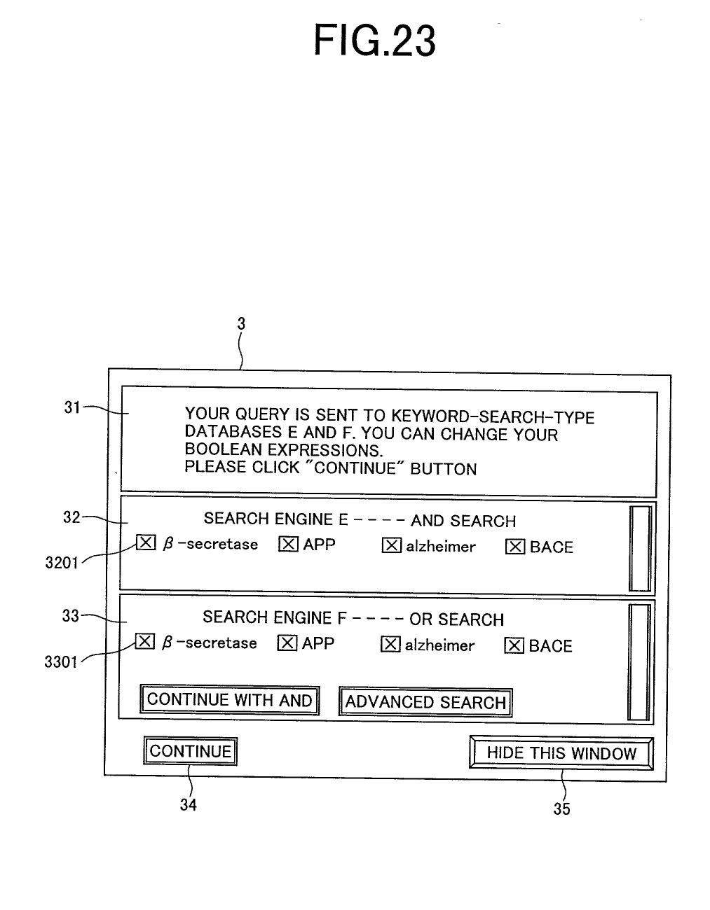

As shown in the topic word area 14 of FIG. 22, upon selecting (checking) the words to be used for a search and clicking the topic word search button 1405, the search is started. The search interface control routine 531 of the search client 600 sends a set of user-selected words to the search server 601 (T21 of FIG. 6). Since the search targets are keyword-search-type DBs, the search server 601 notifies the search client 600 of the request to modify the search expression (T26). The search interface control routine 531 of the search client (as shown in FIG. 23), displays the search request confirmation/modification window 3 and puts the checked words in the areas 32 and 33. The same assumption as described above is applied to the search engines E and F. This time, a case in which the words are not stripped of their check is shown.

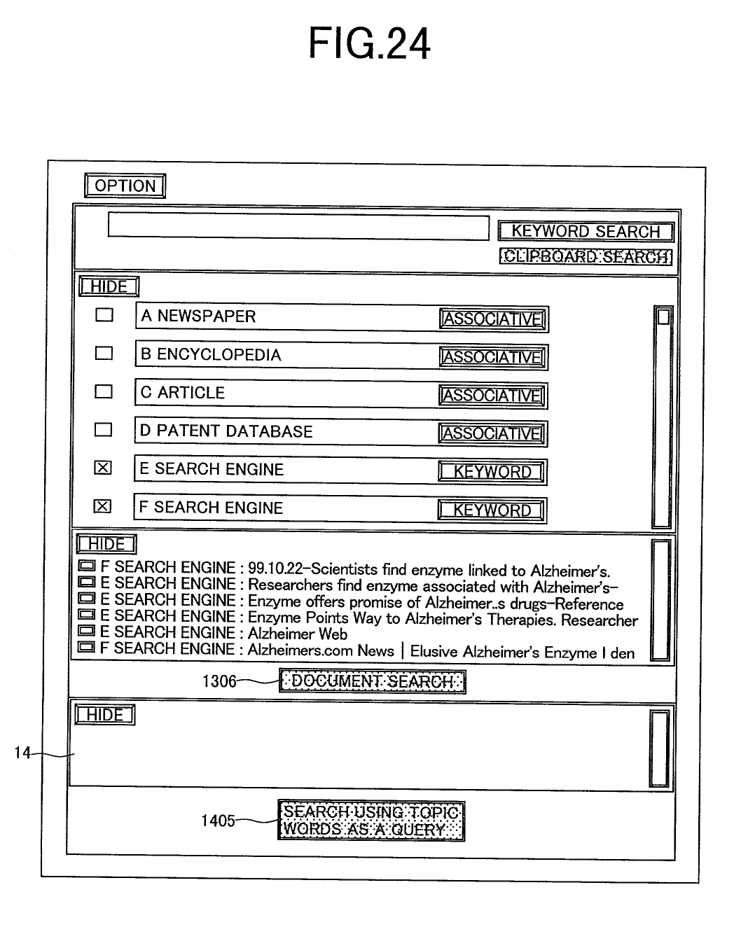

Upon selecting the continue button 34, the confirmed Boolean expression is sent to the search server 601 (T27), and the search server 601 sends the Boolean expression to the keyword-search-type databases E and F through the query constructing means 6012 and obtains search results (T28, T29). The search results are merged by the search result merging means 6013 of the search server, the merged search results are returned to the search interface control routine 531 of the search client (T30), and a search result as shown in FIG. 24 is displayed. In this case, no topic word set is returned, and because search targets are keyword-search-type DBs, the topic word area 14 is empty, and the document associative search button 1306 and the topic word search button 1405 are disabled. This is the same as the case with respect to FIG. 21.

FIGS. 25 and 26 show that, after the search results shown in FIG. 7b are obtained (as shown in the DB specification area 12 of FIG. 25), the DBs to be searched are switched to only the associative-document-search-type DBs B and C and the queries are documents returned from associative-document-search-type DBs (as shown in the document area 13 of FIG. 25).

Upon checking the document selecting buttons 1303 of documents to be used as queries in the document area 13 and clicking the document associative search button 1306, a search is started. The search interface control routine 531 of the search client sends the document IDs to be used as queries and the associative-document-search-type DBs to be searched to the search server (T9 of FIG. 5).

The topic word requesting means 6014 of the search server sends the IDs of specified documents to the associative-document-search-type DBs of the documents to obtain topic word sets (T10, T11). After the topic word sets are merged by the search result merging means 6013, the merged word sets are sent to the specified associative-document-search-type DBs to receive an associative document search result (T12, T13).

Thereafter, document IDs of the search result are sent to associative-document-search-type DBs having sent the document IDs to obtain a set of topic words (T14, T15). After final search results are merged by the search result merging means 6013, a search result is sent to the search client 600 (T20). As a result, a search result as shown in FIG. 26 is produced. Documents are displayed in the document area 13, and a topic word set is displayed in the topic word area 14.

FIGS. 27 and 28 show that, after the search results shown in FIG. 18 are obtained (as shown in the DB specification area 12 of FIG. 27), the DBs to be searched are switched to only the associative-document-search-type DBs B and C and queries are selected directly from a topic word set to perform subsequent search.

Upon clicking the topic word search button 1405 after selecting the words to be used as queries from the topic word area 14, a search is started. The search interface control routine 531 of the search client sends a set of selected topic words to the search server 601 (T21 of FIG. 6). The query constructing means 6012 of the search server sends the set of topic words to the associative-document-search-type databases B and C to obtain the IDs of similar documents as a result of searching (T22, T23).

Thereafter, the search server 601 obtains topic words of similar documents retrieved from the associative-document-search-type databases B and C by the topic word requesting means 6014 (T24, T25); the topic words are merged by the search result merging means 6013; the search results are merged; and the merged search results are sent to the search client 600 (T30). As a result, a search result as shown in FIG. 28 is displayed in the search client 600. Documents are displayed in the document area 13, and a topic word set is displayed in the topic word area 14.

For simplicity, the examples shown in FIGS. 19 to 28 do not show a case of specifying keyword-search-type DBs and associative-document-search-type DBs at the same time. In such a case, search processing is performed as a combination of the search processing in the case where keyword-search-type DBs are specified and the search processing in the case where keyword-search-type DBs are specified.

According to the present invention, a search interface through which a plurality of associative-document-search-type databases and a plurality of keyword-search-type databases are organically combined, the functionality to subsequently search other databases using information obtained by specific databases is highly supported. In this way, users may efficiently retrieve information from different database types without changing their search program multiple times.

The foregoing invention has been described in terms of preferred embodiments. However, those skilled, in the art will recognize that many variations of such embodiments exist. Such variations are intended to be within the scope of the present invention and the appended claims.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A document retrieval system including a user search interface, the system comprising:
a document information display means for displaying document identification information received as the results of an initial search;
a means for selecting at least a portion of the contents of a document identified by the document identification information displayed by the document information display means;
a search button for initiating a subsequent document retrieval using said selected document contents as a query; and
a means for modifying and confirming a Boolean expression that associates a plurality of words included in said query.

2. The document retrieval system of claim 1, further comprising:
a document content display means for displaying the contents of documents identified by the document identification information displayed by the document information display means.

3. The document retrieval system of claim 1, further comprising:
a database selecting part for selecting at least one database to be searched in said subsequent document retrieval, wherein said at least one database is selected from a plurality of databases including keyword-search-type databases and associative-document-search-type databases.

4. The document retrieval system of claim 3, further comprising:
summarizing means for generating topic words for at least a selected portion of a document.

5. The document retrieval system of claim 1, wherein said initial search is a keyword search and said subsequent document retrieval is an associative-document-type search.

6. A document retrieval system including a user search interface, the system comprising:
a document information display part for displaying document information received as search results;
a topic word display part for displaying topic words included in a document referenced in the document information display part;
word selecting means for selecting words displayed in the topic word display part; and
a first search start button for initiating a document retrieval by using the words selected by said word selecting means as a first query.

7. The document retrieval system of claim 6, further comprising:
a means for modifying and confirming a Boolean expression that associates a plurality of words included in said first query.

8. The document retrieval system of claim 6, further comprising:
a database selecting part for selecting at least one database to be searched from a plurality of databases including keyword-search-type databases and associative-document-search-type databases.

9. The document retrieval system as described in claim 8, further comprising:
a means for sending information about the selected databases to be searched and query information to a search server.

10. The document retrieval system of claim 8, further comprising:
a keyword input part for inputting keywords for a keyword search;
document selecting means for selecting documents referenced in the document information display part; and
a second search button for initiating a document retrieval using a document selected by the document selecting means as a second query.

11. The document retrieval system as described in claim 10, further comprising:
document content display means for displaying the contents of a document referenced in the document information display part;
means for registering at least a portion of a document displayed by the document content display means; and
a third search button for initiating a document retrieval by using said registered portion as a third query.

12. The document retrieval system of claim 6, wherein said topic words are automatically generated on a search server by a summarizing means.

13. A document retrieval method, comprising the steps of:
receiving search results from a search server identifying at least one document;
specifying at least a part of a document identified in said search results as a query for a database search;
sending a search request to said search server requesting to search at least one keyword-type database using said query;
modifying and confirming a Boolean expression created by said search server which associates words in said query; and
sending said confirmed Boolean expression to said search server.

14. A document retrieval method, comprising the steps of:
sending a request to perform a keyword search in at least one keyword-search-type database;
receiving document identification information as search results;
specifying at least a part of the contents of the identified search result documents; and
sending a search request to perform a document retrieval in at least one associative-document-search-type database using at least a part of said specified document contents as a query.

15. A document retrieval method, comprising the steps of:
sending a request to perform a document retrieval from at least one associative-document-search-type database;
receiving document IDs and document information including words characterizing the contents of the documents as search results;
selecting at least one word from among the received words; and
sending a search request to perform a keyword search in at least one keyword-search-type database using the selected words as a query.

16. A search server that receives a search request from a document retrieval terminal, issues the search request to specified databases, and sends edited search results to the document retrieval terminal, said search server comprising:
summarizing means for creating a summary from words extracted from at least a part of a document when said at least a part of the document is specified as a search term; and
query constructing means for sending the summary created by the summarizing means to a specified associative-document-search-type database as a query.

17. The search server of claim 16, further comprising:
topic word requesting means for requesting said associative-document-search-type database to create a summary representation of the contents of a document corresponding to a document ID when said document ID is returned from the associative-document-search-type database as a search result, wherein said query constructing means is adapted to send summaries obtained from said associative-document-search-type database by the topic word requesting means to at least one additional associative-document-search-type databases as a query.

18. The search server as described in claim 17, further comprising:
search result merging means for merging a plurality of document summaries to create a set of topic words when said plurality of document summaries are returned from an associative-document-search-type database in response to a request from the topic word requesting means.

19. The search server of claim 16, wherein said search server is adapted to send a document retrieval request to at least one keyword-search-type database and at least one associative-document-search-type database in response to a single search request from the document retrieval terminal.

20. The search server of claim 16, further comprising:
means for requesting confirmation of a Boolean search request for a keyword-search-type database from the document retrieval terminal before issuing said request to the database.
